(19) United States
(12) Patent Application Publication
(10) Pub. No.: US 2015/0130808 A1
(43) Pub. Date: May 14, 2015

(54) DISPLAY DEVICE AND DISPLAY METHOD

(71) Applicant: SONY CORPORATION, Tokyo (JP)

(72) Inventors: Yoshinori Takagi, Kanagawa (JP); Kunio Kawaguchi, Kanagawa (JP); Hiroyuki Morisaki, Kanagawa (JP); Ichiro Ogata, Kanagawa (JP); Hitoshi Mukai, Kanagawa (JP); Seiko Maehara, Kanagawa (JP); Kazumasa Tanaka, Kanagawa (JP); Naoyuki Hirota, Kanagawa (JP)

(73) Assignee: SONY CORPORATION, Tokyo (JP)

(21) Appl. No.: 14/397,985

(22) PCT Filed: Apr. 15, 2013
(86) PCT No.: PCT/JP2013/061190

§ 371 Date: Oct. 30, 2014

(30) Foreign Application Priority Data
May 7, 2012 (JP) 2012-105732

(51) Int. Cl. G09G 5/06

(52) U.S. Cl. CPC G09G 5/06; G09G 2354/00; G09G 2340/06; G09G 2340/0407
USPC 345/428; 345/594

(57) ABSTRACT

There is provided a display device, including a color display section which displays a color plane expressed by first and second attribute values from among three attribute values constituting a color system, a base section to which the color display section is connected in a rotatable state, and a display control section which changes the color plane in accordance with a rotation angle of the color display section.

### TECHNICAL FIELD

The present disclosure relates to a display device and a display method.

### BACKGROUND ART

In the fields of image expression and publication relations, such as represented by color correction, the specification of colors is an important element. When a color is specified, a three-dimensional color space can be considered which is expressed by three attribute values representing elements of the color. As an expression method of a color space, for example, there is RGB which is an expression method of an additive color mixture, CMY which is an expression method of a subtractive color mixture, HSV used by color samples or the like. In addition, expression methods, such as ARGB which takes into consideration an alpha channel (a measure of transparency) in addition to RGB, or CMYK which adds black color to CMY, are also widely used.

Such a three-dimensional color space is expressed on a two-dimensional display of a computer, and it may be necessary to exercise ingenuity in a user interface which is used for the specification of a color, so that a desired color can be specified from this color space. For example, a graphical user interface (hereinafter, GUI) is disclosed in Patent Literature 1 for selecting a color from a color space expressed by HSV. For example, the GUI disclosed in FIG. 19 of Patent Literature 1 can specify each of a hue, saturation and brightness by a slide bar.

### CITATION LIST

### Patent Literature

Patent Literature 1: JP 2007-096612A

### SUMMARY OF INVENTION

### Technical Problem

However, in the GUI disclosed in Patent Literature 1, there is no function which specifies a color while confirming an actual color. Further, the viewpoint of immediately specifying a color from a color space expressed three-dimensionally is not considered at all. Note that, in the field of color correction or the like, when color specification is performed, a large number of color sample books, Munsell charts or the like are used which are expressed one-dimensionally or two-dimensionally. However, when the resolution of a color is raised, a large amount of paper of color samples or Munsell charts may be necessary, a wide location may be necessary, and it will be difficult to retrieve a desired color.

Accordingly, the present disclosure has been conceived in response to such a situation, and is intended to provide a new and improved display device and display method capable of expressing a color space of a high resolution with space savings.

### Solution to Problem

According to an embodiment of the present disclosure, there is provided a display device, including a color display section which displays a color plane expressed by first and second attribute values from among three attribute values constituting a color system, a base section to which the color display section is connected in a rotatable state, and a display control section which changes the color plane in accordance with a rotation angle of the color display section.

According to another embodiment of the present disclosure, there is provided a display method, including changing, by a display device having a color display section which displays a color plane expressed by first and second attribute values from among three attribute values constituting a color system, and a base section to which the color display section is connected in a rotatable state, the color plane in accordance with a rotation angle of the color display section.

### Advantageous Effects of Invention

According to the present disclosure such as described above, it becomes possible to express a color space of a high resolution with space savings.

### BRIEF DESCRIPTION OF DRAWINGS

FIG. 1 is an explanatory diagram which shows a configuration example of a color sample.

FIG. 2 is an explanatory diagram which shows a configuration example of a display device according to a first embodiment of the present disclosure.

FIG. 3 is an explanatory diagram which shows a configuration example of the display device according to the same embodiment.

FIG. 4 is an explanatory diagram which shows a configuration example of the display device according to the same embodiment.

FIG. 5 is an explanatory diagram which shows a configuration example of the display device according to the same embodiment.

FIG. 6 is an explanatory diagram which shows a configuration example of the display device according to the same embodiment.

FIG. 7 is an explanatory diagram which shows a configuration example of the display device according to the same embodiment.

FIG. 8 is an explanatory diagram which shows a configuration example of the display device according to the same embodiment.

FIG. 9 is an explanatory diagram which shows a configuration example of the display device according to the same embodiment.

FIG. 10 is an explanatory diagram which shows a configuration example of the display device according to the same embodiment.

FIG. 11 is an explanatory diagram which shows a configuration example of the display device according to the same embodiment.

FIG. 12 is an explanatory diagram which shows a configuration example of the display device according to the same embodiment.

FIG. 13 is an explanatory diagram which shows a configuration example of the display device according to the same embodiment.

FIG. 14 is an explanatory diagram which shows a configuration example of the display device according to the same embodiment.

FIG. 15 is an explanatory diagram which shows a configuration example of the display device according to the same embodiment.

FIG. 16 is an explanatory diagram which shows a configuration example of the display device according to the same embodiment.

FIG. 17 is an explanatory diagram which shows a configuration example of the display device according to the same embodiment.

FIG. 18 is an explanatory diagram which shows a configuration example of the display device according to the same embodiment.

FIG. 19 is an explanatory diagram which shows a configuration example of the display device according to the same embodiment.

FIG. 20 is an explanatory diagram which shows a configuration example of the display device according to the same embodiment.

FIG. 21 is an explanatory diagram which shows a configuration example of the display device according to the same embodiment.

FIG. 22 is an explanatory diagram which shows a configuration example of the display device according to the same embodiment.

FIG. 23 is an explanatory diagram which shows a configuration example of the display device according to the same embodiment.

FIG. 24 is an explanatory diagram which shows a configuration example of the display device according to the same embodiment.

FIG. 25 is an explanatory diagram which shows a configuration example of the display device according to the same embodiment.

FIG. 26 is an explanatory diagram which shows a configuration example of the display device according to the same embodiment.

FIG. 27 is an explanatory diagram which shows a configuration example of the display device according to the same embodiment.

FIG. 28 is an explanatory diagram which shows a configuration example of the display device according to the same embodiment.

FIG. 29 is an explanatory diagram which shows a configuration example of the display device according to the same embodiment.

FIG. 30 is an explanatory diagram which shows a configuration example of the display device according to the same embodiment.

FIG. 31 is an explanatory diagram which shows a configuration example of the display device according to the same embodiment.

FIG. 32 is an explanatory diagram which shows a configuration example of the display device according to the second embodiment of the present disclosure.

FIG. 33 is an explanatory diagram which shows a configuration example of the display device according to the same embodiment.

FIG. 34 is an explanatory diagram which shows a configuration example of the display device according to the same embodiment.

FIG. 35 is an explanatory diagram which shows a configuration example of the display device according to the same embodiment.

FIG. 36 is an explanatory diagram which shows a configuration example of the display device according to the same embodiment.

FIG. 37 is an explanatory diagram which shows a hardware configuration example capable of implementing the functions of the display device according to the first and the second embodiments of the present disclosure.

### DESCRIPTION OF EMBODIMENTS

Hereinafter, preferred embodiments of the present invention will be described in detail with reference to the appended drawings. Note that, in this specification and the drawings, elements that have substantially the same function and structure are denoted with the same reference signs, and repeated explanation is omitted.

### (The Flow of the Description)

Here, the flow of the description shown hereinafter will be simply stated.

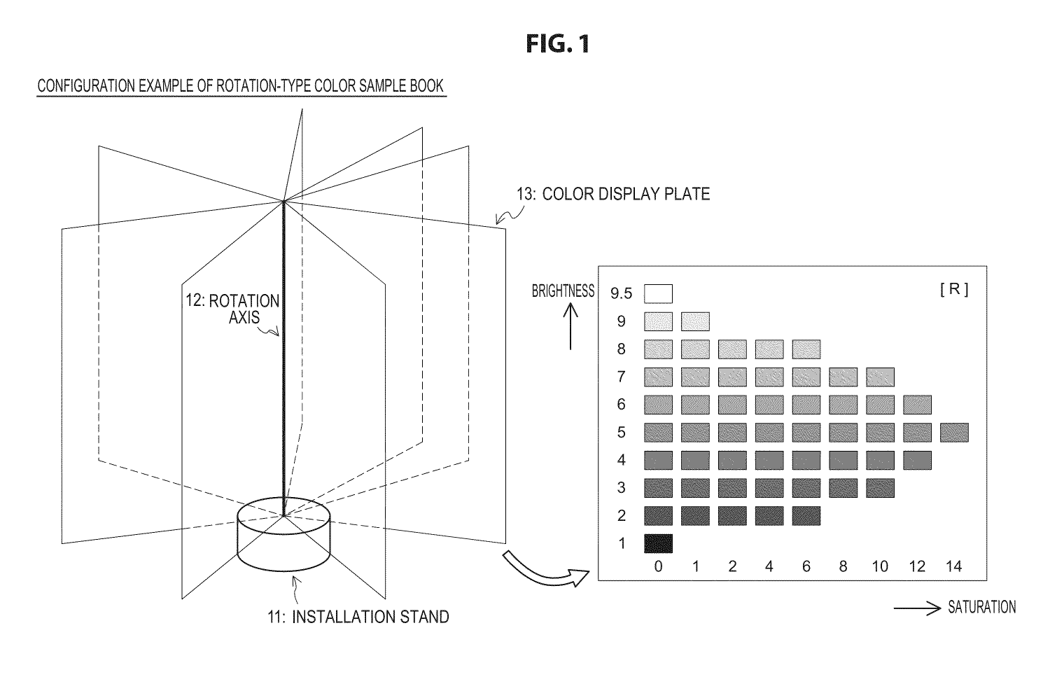

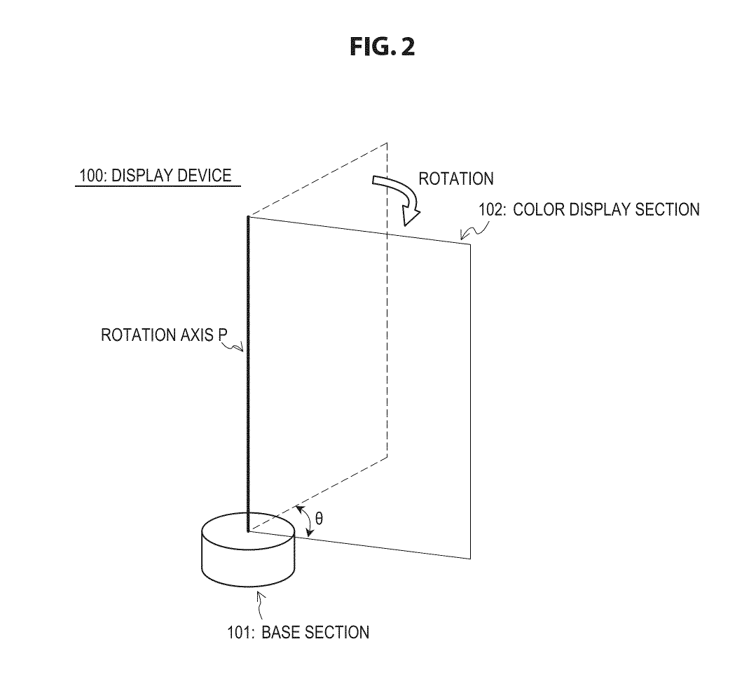

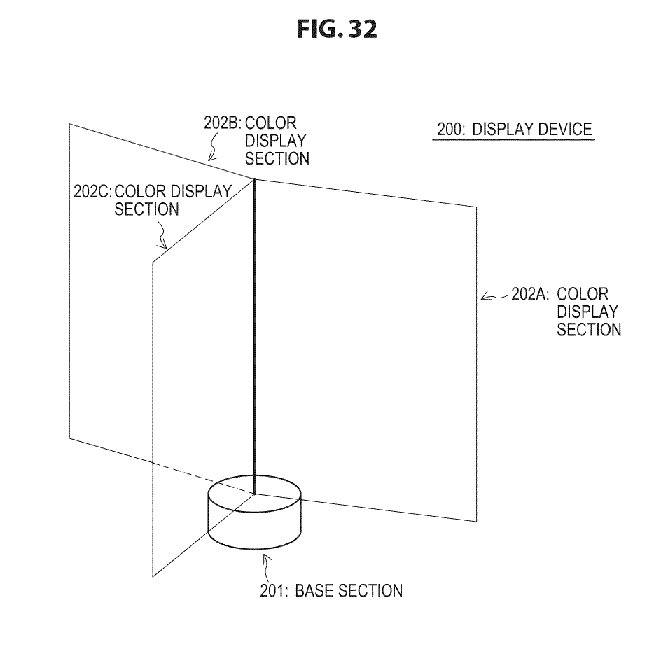

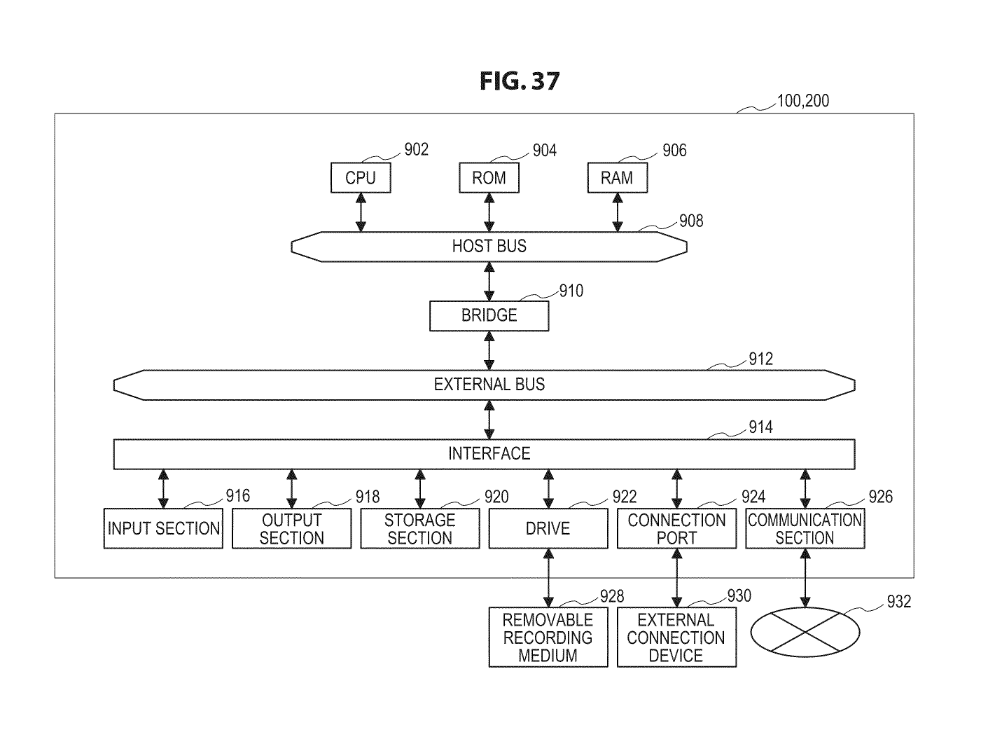

First, a configuration example of a Munsell color chart and a rotation-type color sample book using transparent plates will be introduced with reference to FIG. 1. Next, various types of configuration examples of a display device 100 according to a first embodiment of the present disclosure will be described with reference to FIG. 2 to FIG. 31. Next, various types of configuration examples of a display device 200 according to a second embodiment of the present disclosure will be described with reference to FIG. 32 to FIG. 36. Next, a hardware configuration example capable of implementing a control function, a calculation function or the like of the display devices 100 and 200 will be described with reference to FIG. 37. Finally, the technical idea of the same embodiments will be concluded, and the working effect obtained from this technical idea will be simply described.

### (Description Items)

0: Introduction
1: The first embodiment (in the case where there is one color plane)
1-1 Basic configuration of the display device 100
1-1-1: External appearance and display operation
1-1-2: Functional configuration
1-1-3: Operation
1-1-4: Modified example 1 (automatic driving)
1-1-5: Modified example 2 (configuration using an information terminal)
1-2: Configuration of the display device 100 equipped with an input function
1-2-1: Functional configuration
1-2-2: Operation
1-2-3 Display operation at the time of color specification
1-2-4: History function
1-2-5: External output function
1-2-6: Color mixing function
1-3: Configuration of the display device 100 equipped with a resolution switching function
1-3-1: The resolution switching function
1-3-2: Functional configuration
1-3-3: Operation
1-4: Configuration of the display device 100 equipped with a mode switching function
1-4-1: The mode switching function
1-4-2: Functional configuration
1-4-3: Operation
1-5: Configuration of the display device 100 equipped with a color space conversion function
1-5-1: The color space conversion function
1-5-2: Functional configuration
1-5-3: Operation 1 (manual switching)
1-5-4: Operation 2 (time division switching)
1-6: Configuration of the display device 100 equipped with an image input function
1-6-1: The image input function
1-6-2: Functional configuration
1-6-3: Operation
1-6-4: Modified example (application to character input)
2: The second embodiment (in the case where there are a plurality of color planes)
2-1: Basic configuration of the display device 200
2-1-1: External appearance and display operation
2-1-2: Functional configuration
2-1-3: Operation
2-2: Configuration of the display device 200 equipped with a mode switching function
2-2-1: The mode switching function
2-2-2: Functional configuration
2-2-3: Operation
2-3: Combination of various types of functions
2-3-1: Combination with an input function
2-3-2: Combination with a resolution switching function
2-3-3: Combination with a color space conversion function
2-3-4: Combination with an image input function
3: Hardware configuration example
4: Conclusion

### 0: Introduction (FIG. 1)

First, a configuration example of a Munsell color chart will be stated, and a rotation-type color sample book using transparent plates will be introduced, with reference to FIG. 1. Note that, while the present disclosure will be described by using a case of a Munsell color system (HSV color space) as an example, it is possible to apply the technology described in the present disclosure for color spaces of various types of color systems, such as an RGB color system, an XYZ color system, an xyY color system, an L*u*v* color system or an L*a*b* color system.

A Munsell color system expresses a color space by the three attributes of hue, brightness and saturation. Accordingly, in the case where a desired color is specified by a Munsell color system, a hue is specified by using a Munsell hue circle or the like, and a desired color is specified from a Munsell color chart corresponding to this hue. A Munsell color chart has a configuration such as that of the right side of FIG. 1, and is a color map which sets a horizontal axis to the saturation and a vertical axis to the brightness. Munsell color charts are prepared only for the number of color hues expressed by a Munsell hue circle. Accordingly, when the number of hues expressed by a Munsell hue circle becomes large (when the resolution related to the hue becomes high), the number of Munsell color charts to be prepared will become large. Further, since a Munsell hue circle is a one-dimensional map, and a Munsell color chart is a two-dimensional map, it will be difficult to image a three-dimensional color space by combining these.

Accordingly, a rotation-type color sample book such as that shown in FIG. 1 has been devised. This rotation-type color sample book is constituted by an installation stand 11, a rotation axis 12, and a plurality of color display plates 13. For example, the color display plates 13 are constituted by transparent glass plates or the like on which Munsell color charts are printed. By being constituted so that each of the color display plates 13 can rotate by setting the rotation axis 12 as a center axis, a high operability is achieved. Further, by having a plurality of color display plates 13 included which correspond to mutually different hues, a three-dimensional color space can be imaged.

However, it may be necessary to increase the number of the color display plates 13 in order to increase the resolution. It is needless to say that while the installation area will not necessarily widen even if the number of color display plates 13 increases, the density of the color display plates 13 will increase, and so the operability and visibility will be reduced. Further, there is a connection to a high cost when the number of the color display plates 13 increases. Accordingly, the present inventors have devised a display device (the display devices 100 and 200, which will be described later) which electronically displays a color plane such as a Munsell color chart, and which does not cause a reduction of the operability and visibility even if set to a high resolution. Hereinafter, configurations of this display device will be described.

### 1: The First Embodiment

### In the Case where there is One Color Plane

Hereinafter, a first embodiment of the present disclosure will be described. The present embodiment is related to a configuration of a display device 100 in which one display device (a color display section 102) which displays a color plane is included.

### 1-1: Basic Configuration of the Display Device 100

A basic configuration of the display device 100 according to the present embodiment will be described.

### 1-1-1: External Appearance and Display Operation (FIG. 2 to FIG. 4)

As shown in FIG. 2, the display device 100 according to the present embodiment has a base section 101, and a color display section 102 connected to the base section 101 in a rotatable state with reference to a rotation axis P. The color display section 102 is a display device capable of displaying a color plane such as a Munsell color chart. For example, a thin display such as a liquid crystal display or an organic electroluminescent display can be used as the color display section 102. Further, for example, a flexible display or the like constituted by an organic thin film transistor is capable of being applied as a form of the color display section 102.

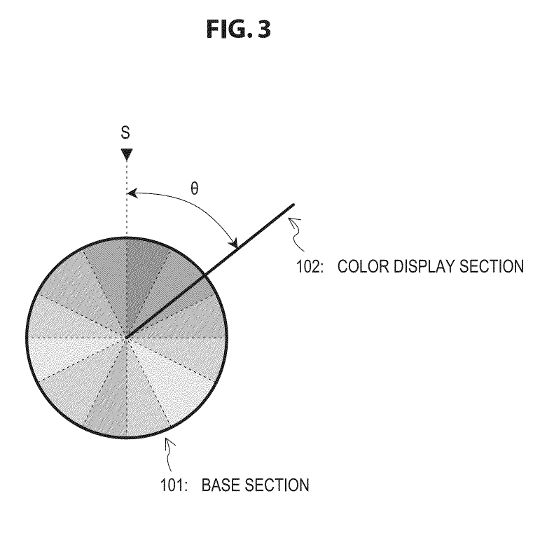

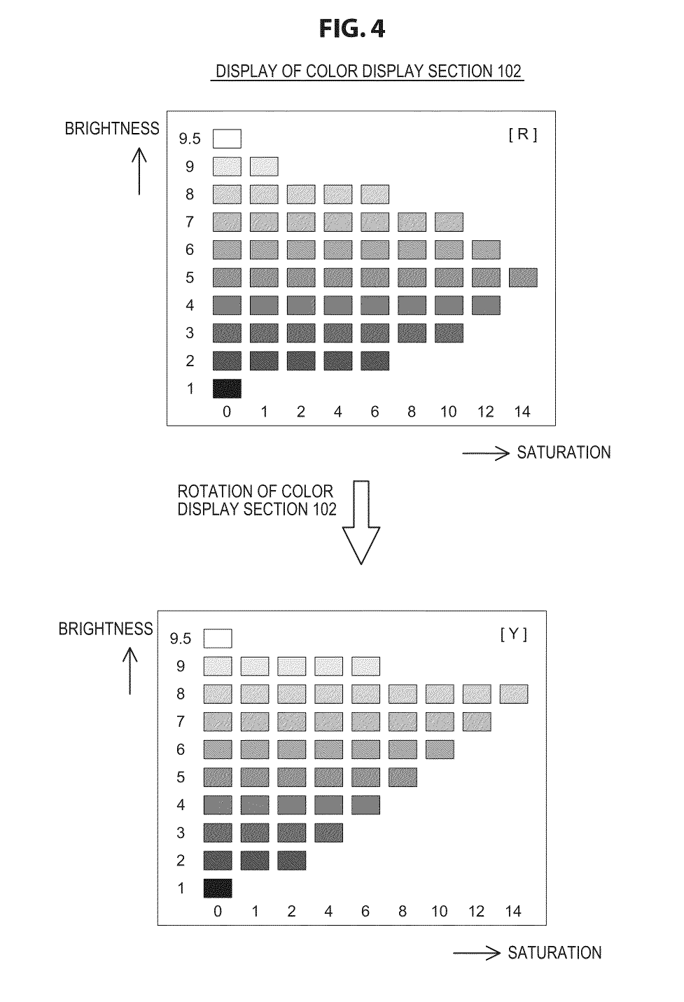

The color plane displayed on the color display section 102 is constituted so as to change in accordance with a rotation angle of the color display section 102. Specifically, as shown in FIG. 3, some standard direction S is set, and the color plane displayed on the color display section 102 changes in accordance with a rotation angle with respect to this standard direction S. For example, certain rotation angles from the standard direction S and color hues are associated with each other, and in accordance with the rotation angles from the standard direction S, as shown in FIG. 4, a Munsell color chart of the hues corresponding to these rotation angles are shown on the color display section 102. In the example of FIG. 4, a state is shown in which the display content of the color display section 102 is changed from a state in which a Munsell color chart corresponding to a hue R is displayed to a state in which a Munsell color chart corresponding to a hue Y is displayed, by the rotation of the color display section 102.

As described above, the display device 100 has a function which changes the content of the color plane displayed on the color display section 102 by a rotation operation of the color display section 102. Note that, it may be constituted so that the color plane continuously changes in accordance with the rotation of the color display section 102, or may be constituted so as to change by discretely changing. Further, in the case of being constituted so as to discretely change, this change amount (for example, an association relation between a rotation angle width and a change width of the hue) is capable of being arbitrarily set. That is, the display device 100 according to the present embodiment is capable of achieving a high resolution without sacrificing elements such as operability and visibility. Hereinafter, a functional configuration of the display device 100 having this basic configuration will be described in more detail.

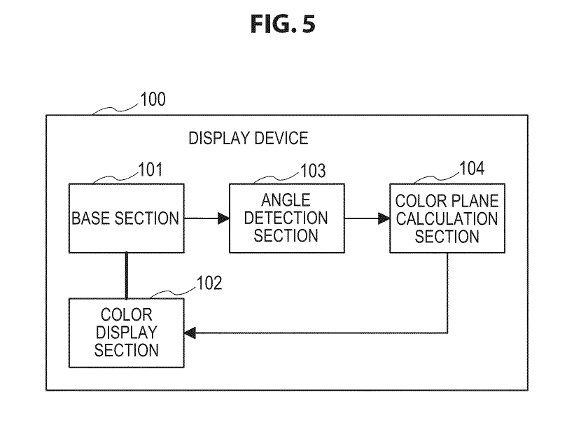

### 1-1-2: Functional Configuration (FIG. 5)

A functional configuration of the display device 100 having a basic configuration will be described with reference to FIG. 5. As shown in FIG. 5, this display device 100 mainly has a base section 101, a color display section 102, an angle detection section 103, and a color plane calculation section 104. The angle detection section 103 is a means which detects a rotation angle of the color display section 102 with reference to a standard direction S. The rotation angle detected by the angle detection section 103 is input to the color plane calculation section 104. The color plane calculation section 104 selects a hue corresponding to the input rotation angle, and calculates a color plane corresponding to the selected hue. In addition, the color plane calculation section 104 causes the color display section 102 to display the calculated color plane. Note that, the color plane calculation section 104 may display a color plane which takes into account an alpha value representing transparency.

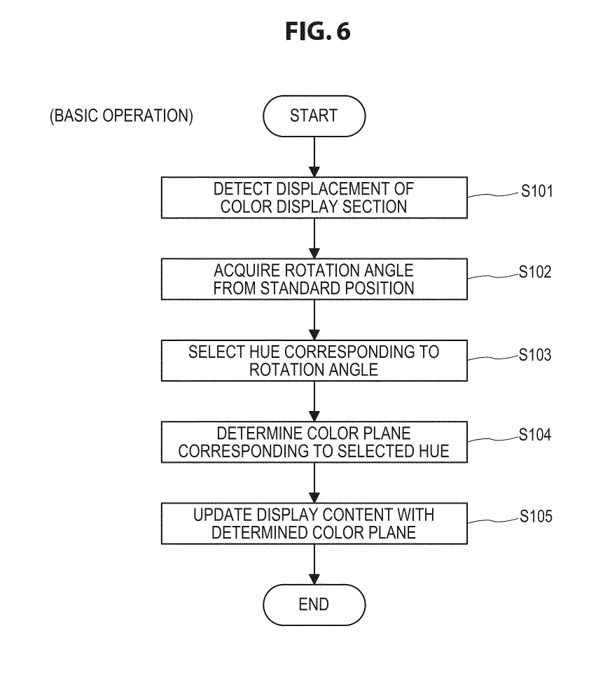

### 1-1-3: Operation (FIG. 6)

Next, an operation of the display device 100 having a basic configuration will be described with reference to FIG. 6. As shown in FIG. 6, first, the display device 100 detects a displacement of the color display section 102, by a function of the angle detection section 103 (S101). Next, the display device 100 acquires a rotation angle of the color display section 102 from a standard position (standard direction S), by a function of the angle detection section 103 (S102). Next, the display device 100 selects a hue corresponding to the rotation angle acquired in step S102, by a function of the color plane calculation section 104 (S103). Next, the display device 100 determines a color plane corresponding to the selected hue, by a function of the color plane calculation section 104 (S104). Next, the display device 100 updates the display content of the color display section 102 with the color plane determined in step S104, by a function of the color plane calculation section 104 (S105), and the series of operations ends. Note that, the operations of steps S101 to S105 are executed each time a displacement of the color display section 102 is detected.

### 1-1-4: Modified Example 1

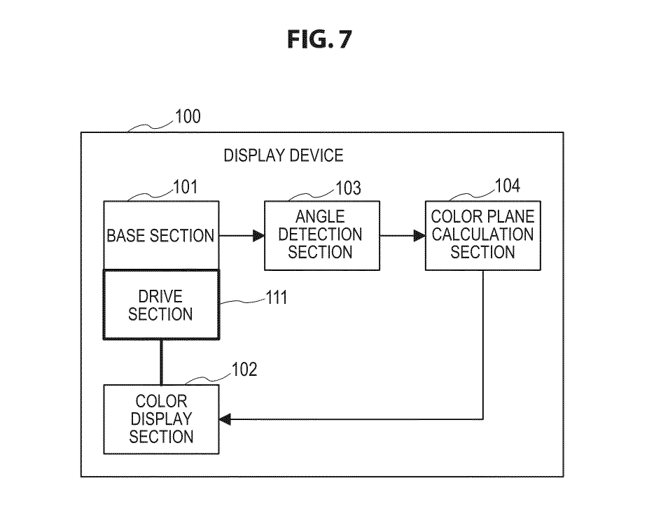

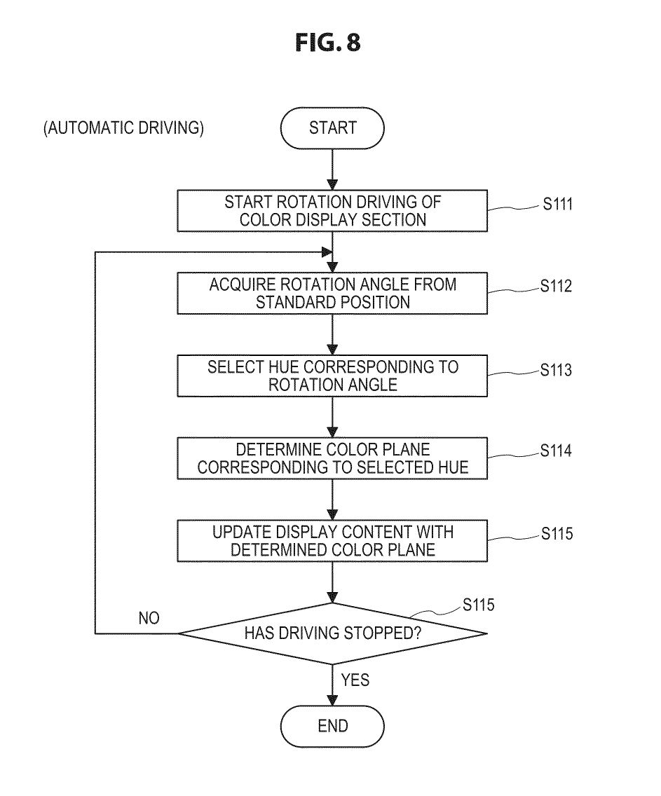

### Automatic Driving (FIG. 7 and FIG. 8)

While it is assumed in the above described description that a user performs a displacement of the color display section 102 manually, a function which automatically drives the color display section 102 may be added to the display device 100. In this case (modified example 1), the functional configuration of the display device 100 is changed such as in FIG. 7. In modified example 1, as shown in FIG. 7, the display device 100 is constituted by a base section 101, a color display section 102, an angle detection section 103, a color plane calculation section 104, and a drive section 111. In this case, the color display section 102 is connected to the base section 101 via the drive section 111. Also, the drive section 111 rotatably drives the color display section 102 by using a drive mechanism such as a motor.

Further, an operation of the display device 100 according to modified example 1 will be that such as in FIG. 8, for example. As shown in FIG. 8, when rotation driving of the color display section 102 starts (S111), the display device 100 acquires a rotation angle of the color display section 102 from a standard position (standard direction S), by a function of the angle detection section 103 (S112). Next, the display device 100 selects a hue corresponding to the rotation angle acquired in step S112, by a function of the color plane calculation section 104 (S113). Next, the display device 100 determines a color plane corresponding to the selected hue, by a function of the color plane calculation section 104 (S114). Next, the display device 100 updates the display content of the color display section 102 with the color plane determined in step S114, by a function of the color plane calculation section 104 (S115),

Next, the display device 100 judges whether or not an operation of drive stopping has been performed (S115). In the case where an operation of drive stopping has been performed, the display device 100 ends the series of processes. On the other hand, in the case where an operation of drive stopping has not been performed, the display device 100 advances the process to step S112. Note that, in the case of automatically rotatably driving the color display section 102, it is preferable to be constituted so that parameters such as this rotation speed or rotation direction can be freely set by a user. Further, in the case where a user manually causes the operation of the color display section 102 to stop, it may be constituted so that the rotation driving of the color display section 102 is stopped. Further, it may be constituted so that the rotation direction is changed with a prescribed timing during rotation driving, or the rotation speed is continuously changed.

### 1-1-5: Modified Example 2

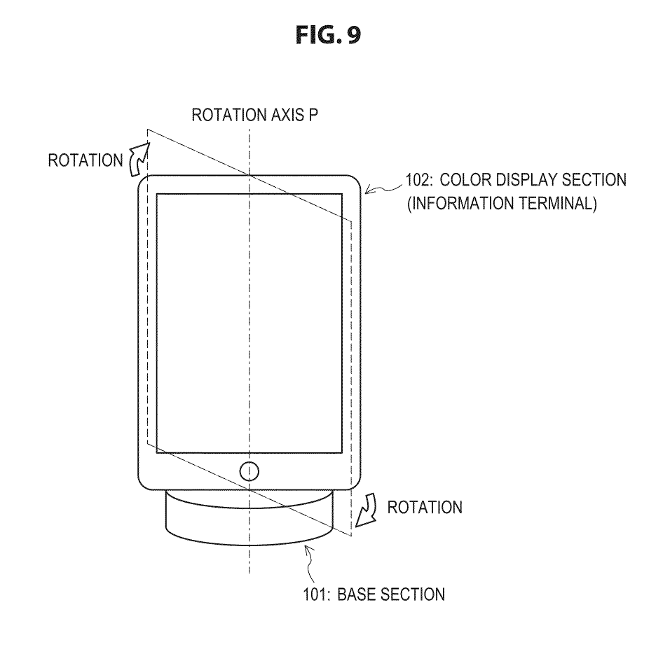

### Configuration Using an Information Terminal (FIG. 9)

Here, one modified example (modified example 2) will be introduced for the form of the color display section 102. A description has been advanced up until now by assuming that the color display section 102 is a display device connected to the display device 100. However, as shown in FIG. 9, it may be constituted so as to use an information terminal as the color display section 102. In this case, an information terminal used as the color display section 102 is mechanically connected via a detachable structure with the base section 101. Further, this information terminal has a configuration which is electrically connected to constituent elements such as the color plane calculation section 104 constituting the display device 100, or is capable of communicating by using a function such as wireless communication. Note that, taking into account stability during rotation, it is preferable to be constituted to be capable of rotating the information terminal with reference to a central axis running through the vertical direction. Further, in the example of FIG. 9, while it is described by including an information terminal as an example, it is possible to be substituted with an electronic device such as a game machine, a mobile phone or a car navigation system.

Heretofore, a basic configuration of the display device 100 has been described.

### 1-2: Configuration of the Display Device 100 Equipped with an Input Function

Next, a configuration of the display device 100 equipped with an input function will be described. This display device 100 functions as an input device for specifying colors.

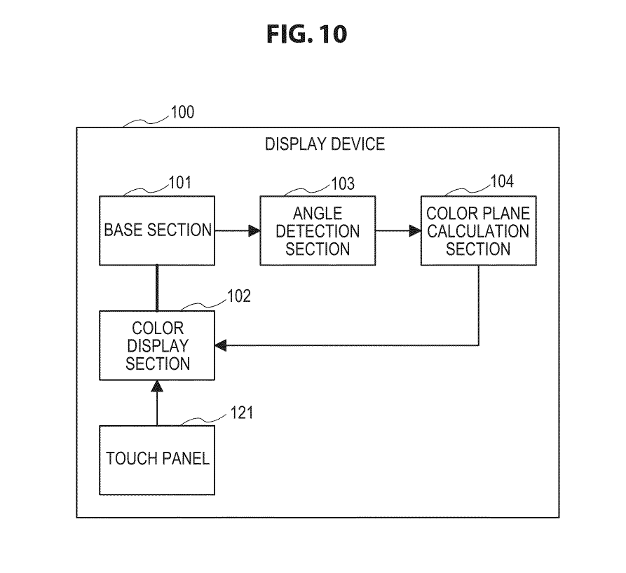

### 1-2-1: Functional Configuration (FIG. 10)

A functional configuration of the display device 100 equipped with an input configuration will be described with reference to FIG. 10. As shown in FIG. 10, this display device 100 mainly has a base section 101, a color display section 102, an angle detection section 103, a color plane calculation section 104, and a touch panel 121. The angle detection section 103 is a means which detects a rotation angle of the color display section 102 with reference to a standard direction S. The rotation angle detected by the angle detection section 103 is input to the color plane calculation section 104. The color plane calculation section 104 selects a hue corresponding to the input rotation angle, and calculates a color plane corresponding to the selected hue. In addition, the color plane calculation section 104 causes the color display section 102 to display the calculated color plane. Further, when a region of the color plane displayed on the color display section 102 is touched via the touch panel 121, the color of the touched region is selected. Note that, it may be constituted so that a rotation operation of the color display section 102 is locked with a timing at which the touch panel 121 has been touched.

### 1-2-2: Operation

Further, since a display operation of the color plane by the display device 100 equipped with an input function is substantially the same as that of the basic operation shown in FIG. 6, a detailed description will be omitted here.

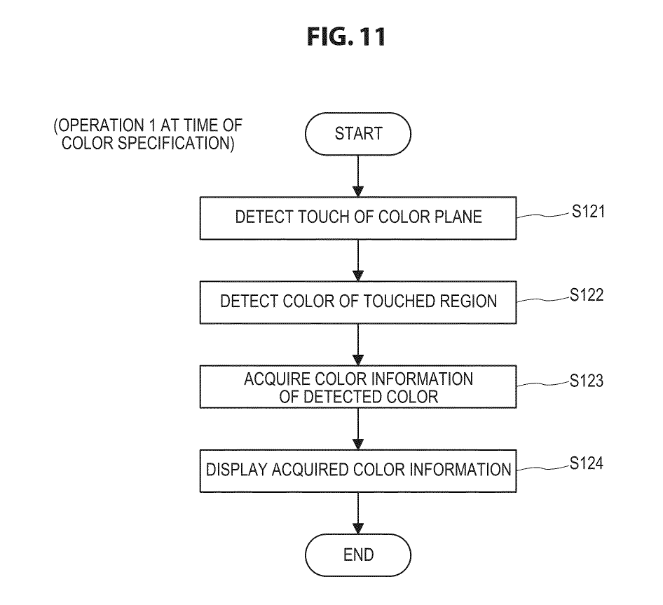

### 1-2-3: Display Operation at the Time of Color Specification (FIG. 11 to FIG. 16)

Here, an operation of the display device 100 at the time of color specification will be described with reference to FIG. 11 to FIG. 16. Note that, the main processes shown hereinafter are implemented by functions of the touch panel 121 and the color display section 102.

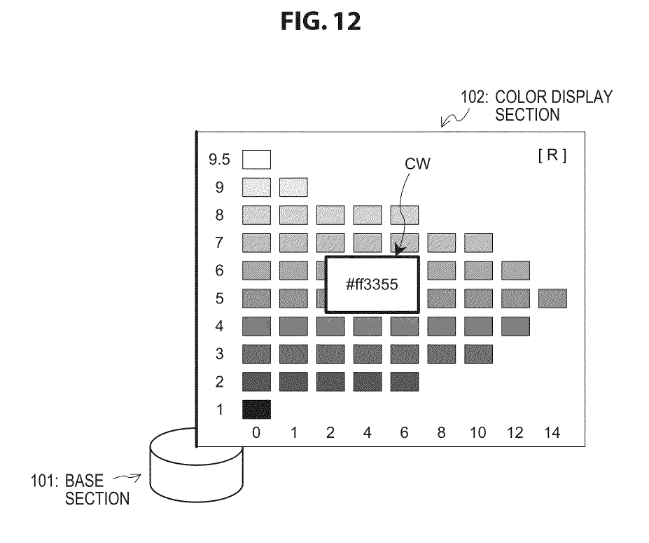

(Display of color information (FIG. 11 and FIG. 12))

First, an operation related to the display of color information will be described. As shown in FIG. 11, when a color plane displayed on the color display section 102 is touched via the touch panel 121, the display device 100 detects the touch of the color plane (S121). Next, the display device 100 detects the color of the touched region (S122). Next, the display device 100 acquires color information of the color detected in step S122 (S123). At this time, the display device 100 acquires color information of the detected color, from among color information recorded in a recording device connected inside or outside of the housing. Next, as shown in FIG. 12, the display device 100 displays the color information acquired in step S123 on the color display section 102 (S124), and the series of processes according to the display of color information ends. In the example of FIG. 12, color information CW which represents a code of colors is displayed on the color display section 102.

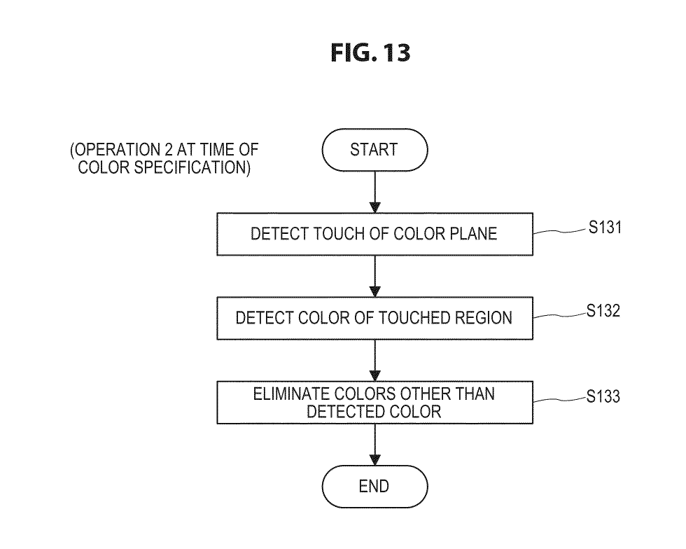

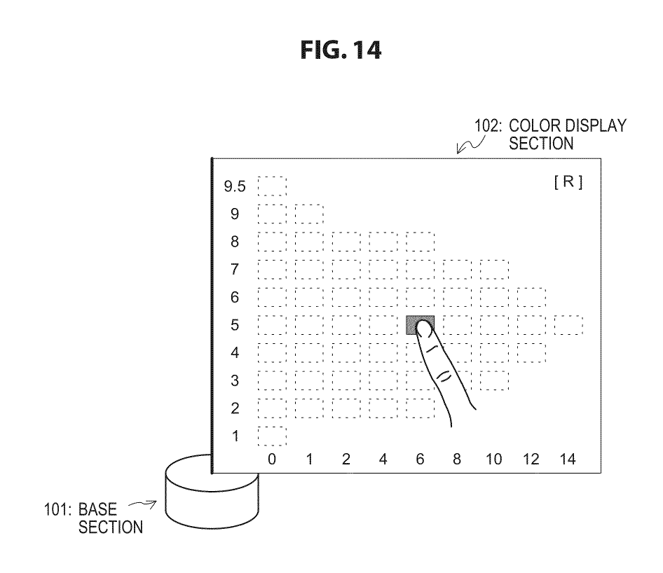

(Eliminating Colors Other than that Specified (FIG. 13 and FIG. 14)

Next, a display operation at the time of color specification will be described. As shown in FIG. 13, when a color plane displayed on the color display section 102 is touched via the touch panel 121, the display device 100 detects the touch of the color plane (S131). Next, the display device 100 detects the color of the touched region (S132). Next, as shown in FIG. 14, the display device 100 eliminates colors other than the color detected in step S132 (S133), and the series of processes related to a display operation at the time of color specification ends. Note that, it may be constituted so that colors other than the specified color eliminated in step S133 are displayed again with a timing at which a finger is released from the touch panel 121.

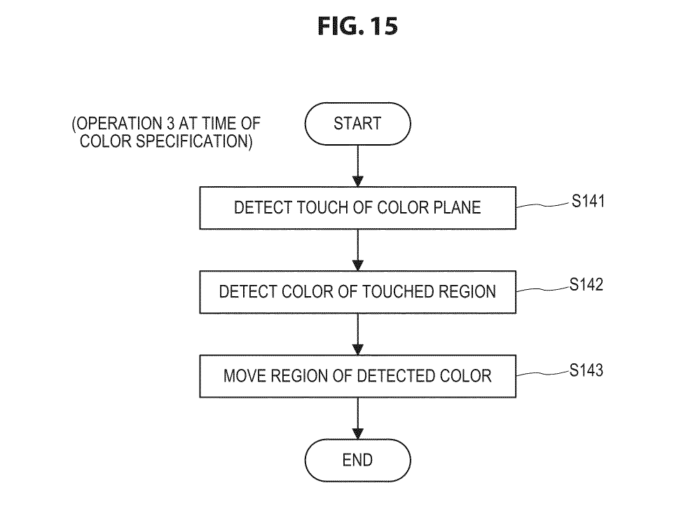

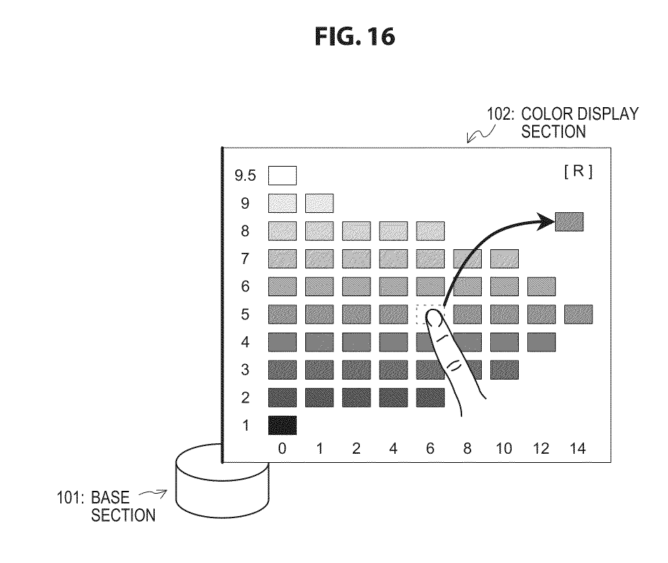

### (Changing a Display Position of the Specified Color (FIG. 15 and FIG. 16))

Next, another display operation at the time of color specification will be described. As shown in FIG. 15, when a color plane displayed on the color display section 102 is touched via the touch panel 121, the display device 100 detects the touch of the color plane (S141). Next, the display device 100 detects the color of the touched region (S142). Next, as shown in FIG. 16, the display device 100 changes a display position of the color region detected in step S142, and the series of processes related to a display operation at the time of color specification ends. Note that, it may be constituted so that the display position of the color region moved in step S143 returns to the original position with a timing at which a finger is released from the touch panel 121.

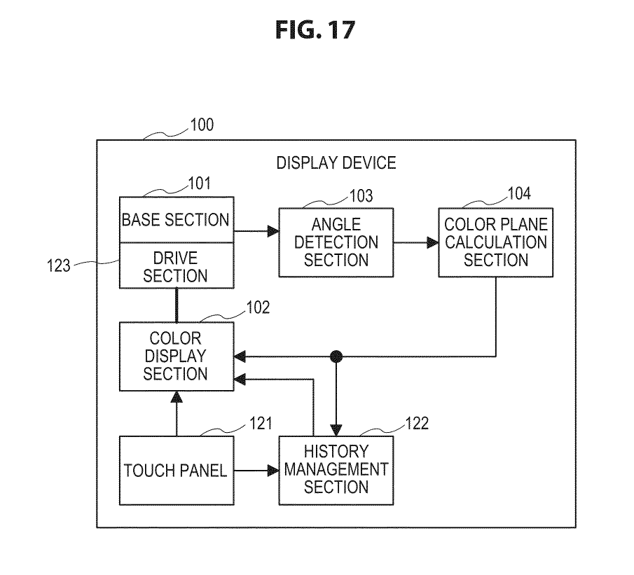

### 1-2-4: History Function (FIG. 17 to FIG. 19)

Here, a configuration and operation of the display device 100 equipped with a function for holding a history of a color specification operation will be described with reference to FIG. 17 to FIG. 19.

### (Configuration of the Display Device 100 (FIG. 17))

As shown in FIG. 17, the display device 100 equipped with a history function mainly has a base section 101, a color display section 102, an angle detection section 103, a color plane calculation section 104, a touch panel 121, a history management section 122, and a drive section 123. The angle detection section 103 is a means which detects a rotation angle of the color display section 102 with reference to a standard direction S. The rotation angle detected by the angle detection section 103 is input to the color plane calculation section 104. The color plane calculation section 104 selects a hue corresponding to the input rotation angle, and calculates a color plane corresponding to the selected hue. In addition, the color plane calculation section 104 causes the color display section 102 to display the calculated color plane. Further, when a region of the color plane displayed on the color display section 102 is touched via the touch panel 121, the color of the touched region is selected.

In addition, when a color is specified via the touch panel 121, information of the specified color is input to the history management section 122 as a history of a color specification operation, and is held by the history management section 122. Further, information of the color plane displayed on the color display section 102 is input to the history management section 122 at the time when a color specification operation is performed, and is held by the history management section 122. For example, information of the hue, information of the rotation angle, information which shows the configuration of the color plane or the like is held by the history management section 122 at the time when a color specification operation is performed. Further, when a color is specified by a user from among the history, the information held along with this color is read, and is reflected in the display content of the color display section 102. For example, when a color is specified from among the history, the history management section 122 causes the color display section 102 to display a color plane which includes this color, by driving the drive section 123, and additionally moves the position of the color display section 102 to a rotation angle corresponding to this color plane.

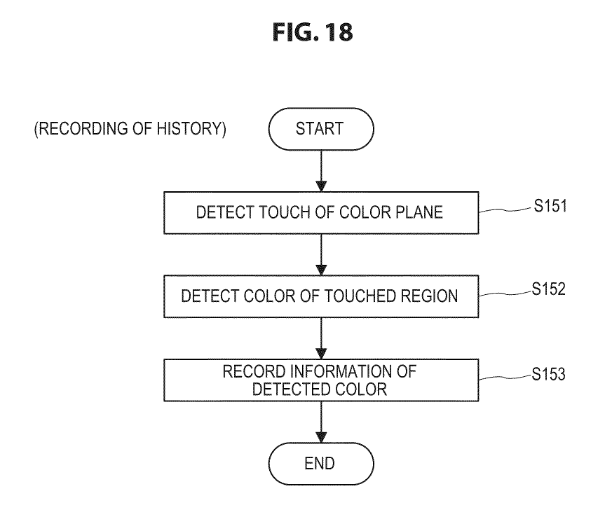

### (Recording Operation of the History (FIG. 18))

Here, a recording operation of the history will be described with reference to FIG. 18. As shown in FIG. 18, when a color plane displayed on the color display section 102 is touched via the touch panel 121, the display device 100 detects the touch of the color plane (S151). Next, the display device 100 detects the color of the touched region (S152). Next, the display device 100 records information of the color detected in step S152, information of the hue, information of the rotation angle, information which shows the configuration of the color plane or the like to a recording device, by a function of the history management section 122 (S153), and the series of processes related to a recording operation of the history ends.

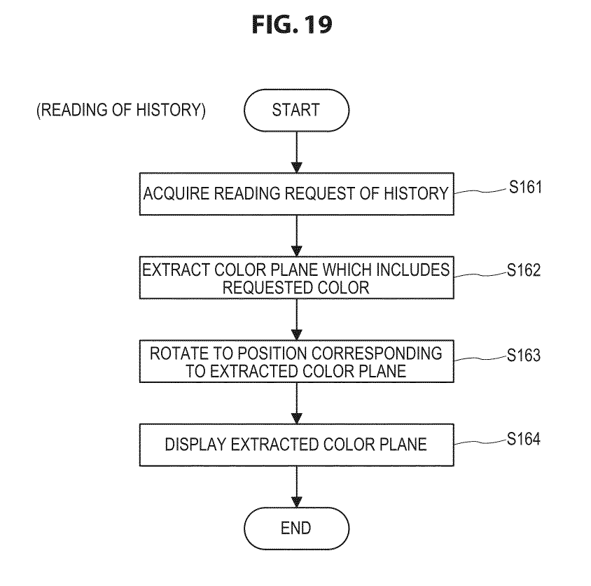

### (Reading Operation of the History (FIG. 19))

Next, a reading operation of the history will be described with reference to FIG. 19. As shown in FIG. 19, when a reading request of the history is acquired (S161), the display device 100 extracts a color plane which includes the color requested in step S161, by a function of the history management section 122 (S162). Next, the display device 100 rotates the color display section 102 to a position corresponding to the color plane extracted in step S162, by a function of the drive section 123 (S163). Next, the display device 100 displays the color plane extracted in step S163 on the color display section 102 (S164), and the series of processes related to a reading operation of the history ends. Note that, the processing order of steps S163 and S164 can be exchanged.

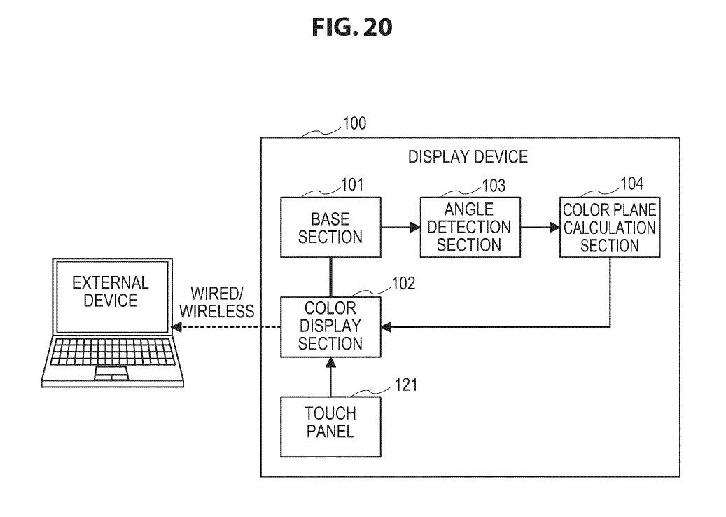

### 1-2-5: External Output Function (FIG. 20)

Also, while a description has be advanced up until now in consideration of using information of a specified color on a display, in the case where this display device 100 is used as an input device, it is preferable to be able to output information of the specified color to an external device. For example, as shown in FIG. 20, it is preferable to be constituted so that information of a specified color is input to the color display section 102 via the touch panel 121, and is provided to an external device by wired (for example, USB, IEEE1394, LAN or the like) or wireless communication (for example, WLAN, IrDA, Bluetooth, a mobile telephone circuit or the like). Note that, in the example of FIG. 20, while a personal computer is drawn as an external device, it may be constituted so that information of a specified color is provided to a device such as a mobile phone, an information terminal or a game machine.

### 1-2-6: The Color Mixing Function

Incidentally, while a description has be advanced in the above described description in consideration of operations which specify one color, the display device 100 may be constituted so as to be able to select a plurality of colors. For example, in the case where a plurality of colors are selected, it may be constituted so that the selected plurality of colors are mixed, and the color after mixing is displayed on the color display section 102. Further, it may be constituted so that the plurality of colors are mixed with a ratio corresponding to a pressing force to the touch panel 121. Further, it may be constituted so that a color plane which includes the color after mixing is selected, and this color plane is displayed on the color display section 102. At this time, it may be constituted so that the color display section 102 automatically moves to a rotation angle corresponding to the selected color plane. In this case, it is preferable to be constituted so that the color display section 102 moves after a finger is released from the touch panel 121.

Heretofore, a configuration and operation of the display device 100 equipped with an input function has been described.

### 1-3: Configuration of the Display Device 100 Equipped with a Resolution Switching Function

Next, a configuration of the display device 100 equipped with a resolution switching function will be described.

### 1-3-1: The Resolution Switching Function

As shown in FIG. 1 or the like, Munsell color charts represent color planes in a matrix, for example, which sets the saturation to a horizontal axis and the brightness to a vertical axis. Accordingly, it is possible to control various amounts of colors capable of being expressed by each of the Munsell color charts by adjusting an interval of the saturation and an interval of the brightness (resolution). Further, a Munsell color chart is included for each hue, and the number of Munsell color charts capable of being switched will change in accordance with the resolution of the hues (number of hues capable of being switched). Note that, a color plane is usually displayed by dividing in each of the steps of 0-14 for the saturation (however, the maximum value will be different in accordance with the hue), and 1-9.5 for the brightness. Hereinafter, a configuration and operation of the display device 100 equipped with a switching function of the resolution such as described above will be described.

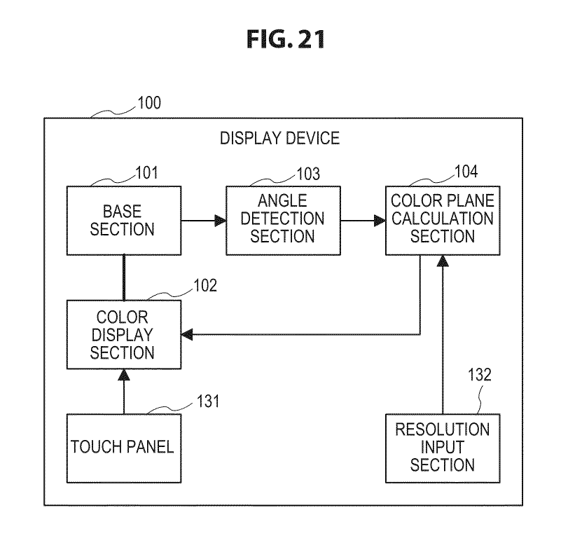

### 1-3-2: Functional Configuration (FIG. 21)

A functional configuration of the display device 100 equipped with the resolution switching function n will be described with reference to FIG. 21. As shown in FIG. 21, this display device 100 mainly has a base section 101, a color display section 102, an angle detection section 103, a color plane calculation section 104, a touch panel 131, and a resolution input section 132. The angle detection section 103 is a means which detects a rotation angle of the color display section 102 with reference to a standard direction S. The rotation angle detected by the angle detection section 103 is input to the color plane calculation section 104. The color plane calculation section 104 selects a hue corresponding to the input rotation angle, and calculates a color plane corresponding to the selected hue. In addition, the color plane calculation section 104 causes the color display section 102 to display the calculated color plane. Further, when a region of the color plane displayed on the color display section 102 is touched via the touch panel 131, the color of the touched region is selected. Note that, it may be constituted so that a rotation operation of the color display section 102 is locked with a timing at which the touch panel 131 has been touched.

Further, when a resolution is specified via the resolution input section 132, information of the specified resolution is input to the color plane calculation section 104. Also, the color plane calculation section 104 again calculates a configuration of the color plane so as to become the input resolution, and displays the color plane after calculating again on the color display section 102. Note that, it may be constituted so that information of the resolution can be input by using the touch panel 131. Further, in the case where information related to the resolution of a color plane is input, or in the case where information related to the resolution of a hue is input, a similar calculation of the color plane will again be performed by the color plane calculation section 104, and will be reflected in the display content of the color display section 102.

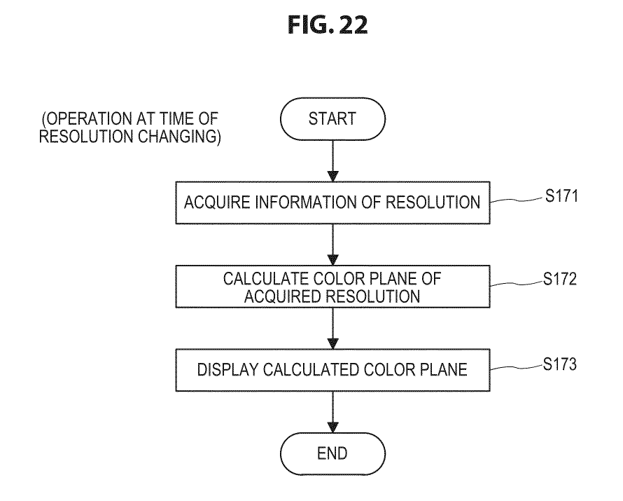

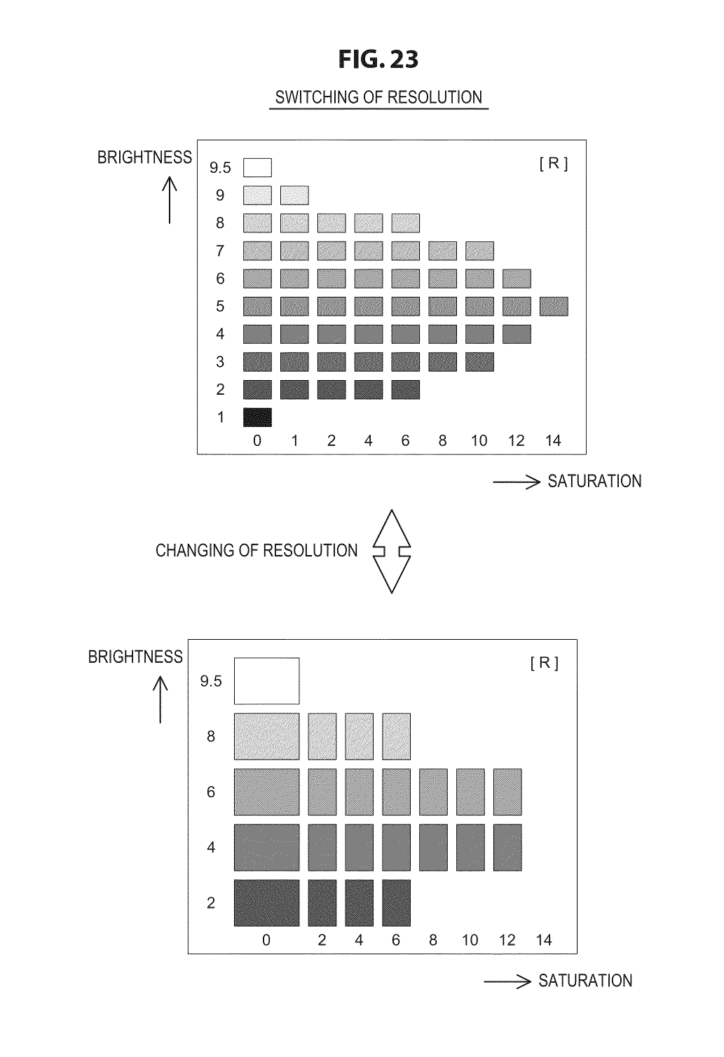

### 1-3-3: Operation (FIG. 22 and FIG. 23)

Next, an operation of the display device 100 in the case where information of a resolution is input will be described with reference to FIG. 22 and FIG. 23. As shown in FIG. 22, first, the display device 100 acquires information of the resolution, by a function of the resolution input section 132 (S171). Next, the display device 100 again calculates the color plane corresponding to this resolution based on the information of the resolution acquired in step S171, by a function of the color plane calculation section 104 (S172). Next, as shown in FIG. 23, the display device 100 displays the color plane which has been calculated again in step S172 on the color display section 102 (S173), and the series of processes according to an operation in the case where information of the resolution is input ends.

Heretofore, a configuration and operation of the display device 100 equipped with a resolution switching function has been described.

### 1-4: Configuration of the Display Device 100 Equipped with a Mode Switching Function

Next, a configuration of the display device 100 equipped with a mode switching function will be described.

### 1-4-1: The Mode Switching Function

A description has been described up until now for a configuration in which the color plane changes in accordance with the rotation angle of the color display section 102. However, there will be cases where, in the case where a desired color plane is obtained, the display of this color plane is wanted to be fixed. In such a case, it is not preferable for the color display section 102 to rotate for some reason, and for the color plane to be changed. Accordingly, the present inventors have devised a function which switches between a color changing mode capable of changing the color plane in accordance with the rotation of the color display section 102 and a color fixing mode in which the color plane is fixed regardless of the rotation of the color display section 102. Hereinafter, a configuration and operation of the display device 100 equipped with this mode switching function will be described.

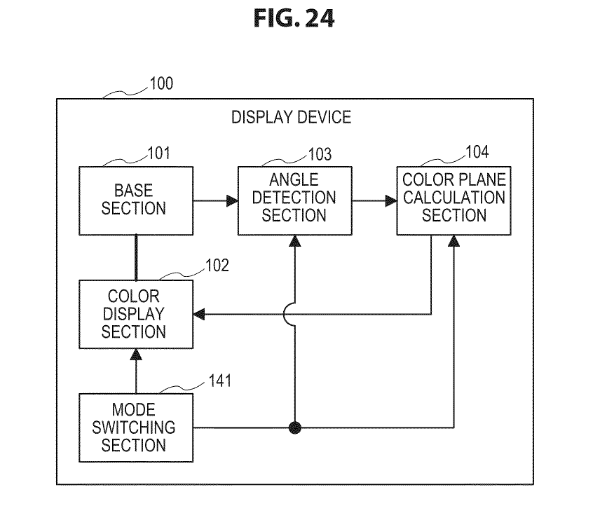

### 1-4-2: Functional Configuration (FIG. 24)

A functional configuration of the display device 100 equipped with a mode switching function will be described with reference to FIG. 24. As shown in FIG. 24, this display device 100 mainly has a base section 101, a color display section 102, an angle detection section 103, a color plane calculation section 104, and a mode switching section 141. The angle detection section 103 is a means which detects a rotation angle of the color display section 102 with reference to a standard direction S. The rotation angle detected by the angle detection section 103 is input to the color plane calculation section 104. The color plane calculation section 104 selects a hue corresponding to the input rotation angle, and calculates a color plane corresponding to the selected hue. In addition, the color plane calculation section 104 causes the color display section 102 to display the calculated color plane.

Further, in the case where the operation mode is set to the color fixing mode, the mode switching section 141 inputs notification signals for notifying the operation mode to the color display section 102, the angle detection section 103 and the color plane calculation section 104, and performs a control so that the color plane does not change in accordance with the rotation of the color display section 102. On the other hand, in the case where the operation mode is set to the color changing mode, the mode switching section 141 inputs notification signals for notifying the operation mode to the color display section 102, the angle detection section 103 and the color plane calculation section 104, and performs a control so that the color plane changes in accordance with the rotation of the color display section 102. In this way, by being able to control the operation mode, it becomes possible to switch the display of the color plane displayed on the color display section 102 between fixing and changing.

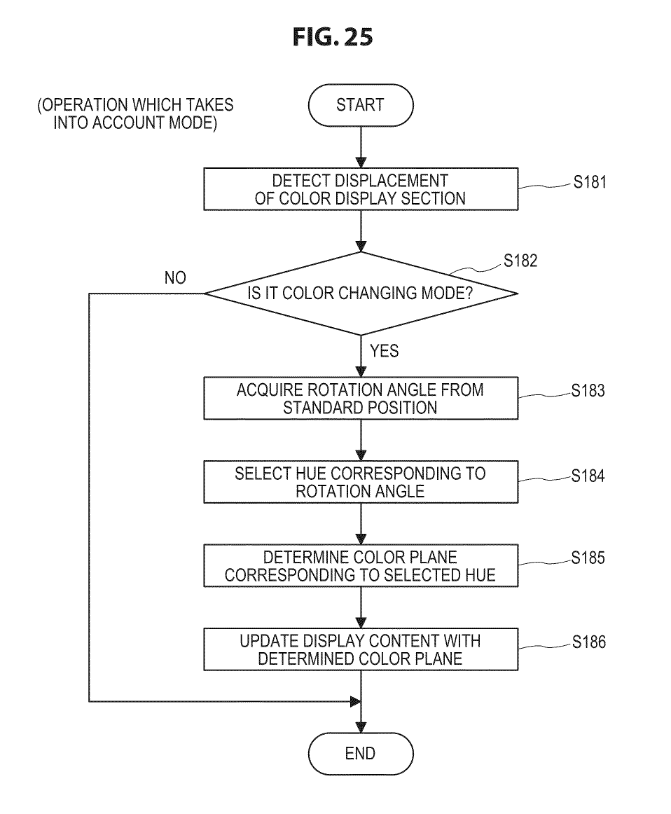

### 1-4-3: Operation (FIG. 25)

Next, an operation of the display device 100 which takes into account the setting of the operation mode will be described with reference to FIG. 25. As shown in FIG. 25, first, the display device 100 detects a displacement of the color display section 102, by a function of the angle detection section 103 (S181). Next, the display device 100 judges whether or not the operation mode is the color changing mode, by a function of the mode switching section 141 (S182). In the case where the operation mode is the color changing mode, the display device 100 advances the process to step S183. On the other hand, in the case where the operation mode is the color fixing mode, the display device 100 ends the process in accordance with a rotation operation of the color display section 102 which takes into account the setting of the operation mode.

In the case where the process has advanced to step S183, the display device 100 acquires a rotation angle of the color display section 102 from a standard position (standard direction S), by a function of the angle detection section 103 (S183). Next, the display device 100 selects a hue corresponding to the rotation angle acquired in step S183, by a function of the color plane calculation section 104 (S184). Next, the display device 100 determines a color plane corresponding to the selected hue, by a function of the color plane calculation section 104 (S185). Next, the display device 100 updates the display content of the color display section 102 with the color plane determined in step S185, by a function of the color plane calculation section 104 (S186), and the series of operations ends. Note that, the operations of steps S181 to S186 are executed each time a displacement of the color display section 102 is detected.

Heretofore, a configuration and operation of the display device 100 equipped with a mode switching function has been described.

### 1-5: Configuration of the Display Device 100 Equipped with a Color Space Conversion Function

Next, a configuration of the display device 100 equipped with a color space conversion function will be described.

### 1-5-1: The Color Space Conversion Function

A person with color blindness will view colors differently. Accordingly, there will be cases in which the display of the color plane will want to be converted for a person with color blindness. For example, conversion information for mutually converting a color plane for a healthy person, a color plane for first color blindness and a color plane for second color blindness is held in the form of a transfer function or a LookUpTable (LUT), and it is desirable to be able to perform switching of the color planes as necessary. Further, other than color planes for color blindness, a function may be included which is capable of converting to color planes having various types of features. In addition, a function may be included which creates an intermediate color plane, by combining a plurality of color planes prepared in advance (for example, by linear interpolation or the like). Note that, since converting each of the color planes is nothing other than the conversion of a color space, this function will be called a color space conversion function. Heretofore, a configuration and operation of the display device 100 equipped with such a color space conversion function will be described.

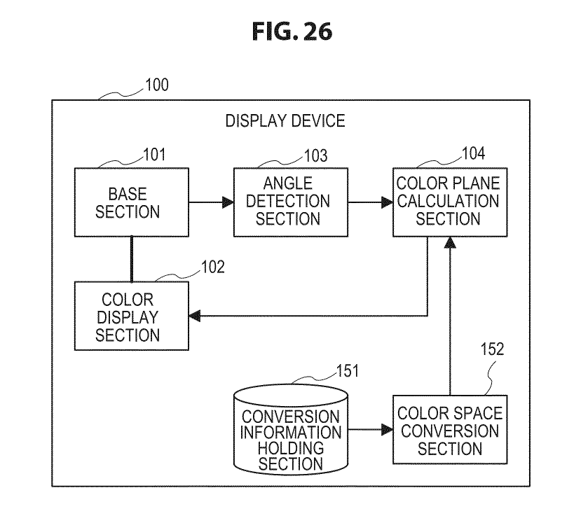

### 1-5-2: Functional Configuration (FIG. 26)

A functional configuration of the display device 100 equipped with a color space conversion function will be described with reference to FIG. 26. As shown in FIG. 26, this display device 100 mainly has a base section 101, a color display section 102, an angle detection section 103, a color plane calculation section 104, a conversion information holding section 151, and a color space conversion section 152. The angle detection section 103 is a means which detects a rotation angle of the color display section 102 with reference to a standard direction S. The rotation angle detected by the angle detection section 103 is input to the color plane calculation section 104. The color plane calculation section 104 selects a hue corresponding to the input rotation angle, and calculates a color plane corresponding to the selected hue. In addition, the color plane calculation section 104 causes the color display section 102 to display the calculated color plane.

Further, a plurality of types of conversion information are stored in the conversion information holding section 151. For example, conversion information for converting a color plane for a healthy person into a color plane for first color blindness and conversion information for converting a color plane for a healthy person into a color plane for second color blindness are stored in the conversion information holding section 151. Also, in the case where conversion of a color plane is requested, the color space conversion section 152 reads the conversion information to be used for the requested conversion of the color plane from the conversion information holding section 151, and inputs the read conversion information to the color plane calculation section 104. The color plane calculation section 104 to which the conversion information has been input converts the color plane by using the input conversion information, and causes the color display section 102 to display the color plane after conversion.

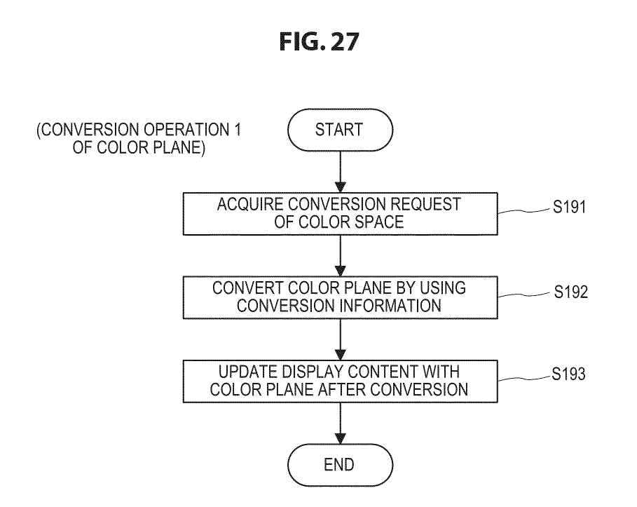

### 1-5-3: Operation 1 (Manual Switching) (FIG. 27)

Next, a conversion operation of a color plane will be described with reference to FIG. 27. As shown in FIG. 27, the display device 100 acquires a conversion request of a color plane input by a user (S191). Next, the display device 100 converts the color space by using conversion information read from the conversion information holding section 151 by the color space conversion section 152, by a function of the color plane calculation section 104 (S192). Next, the display device 100 updates the display content of the color display section 102 with the color plane after conversion (S193), and the series of processes related to a conversion of the color plane ends.

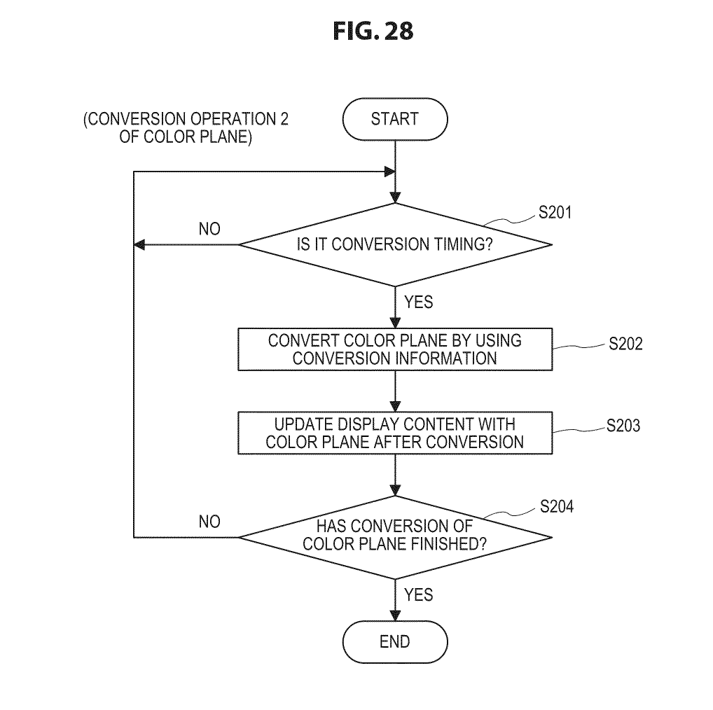

### 1-5-4: Operation 2 (Time Division Switching) (FIG. 28)

The conversion operation of the color plane shown in FIG. 27 is an operation based on a manual input of a conversion request by a user. However, as shown in FIG. 28, it may be constituted so that a plurality of types of color planes are automatically switched by time division. In this case, first, the display device 100 judges whether or not it has become a timing (hereinafter, a conversion timing) which switches the color plane (S201). In the case where it has become a conversion timing, the display device 100 advances the process to step S202. On the other hand, in the case where it has not become a conversion timing, the display device 100 returns the process to step S201.

In the case where the process has advanced to step S202, the display device 100 selects conversion information in an order determined in advance or randomly, and converts the color plane by using the selected conversion information (S202). Next, the display device 100 updates the display content of the color display section 102 with the color plane after conversion (S203). Next, the display device 100 judges whether or not the conversion of the color plane has finished (S204). For example, in the case where an operation is performed in which an automatic conversion operation of the color plane is finished by a user, the display device 100 ends the conversion of the color plane, and the series of processes according to a conversion of the color plane ends. On the other hand, in the case where the conversion of the color plane has not finished, the display device 100 returns the process to step S201.

Heretofore, a configuration and operation of the display device 100 equipped with a color space conversion function has been described.

### 1-6: Configuration of the Display Device 100 Equipped with an Image Input Function

Next, a configuration of the display device 100 equipped with an image input function will be described.

### 1-6-1: The Image Input Function

Up until here, a method which adjusts a rotation angle of the color display section 102 has been introduced as a method which specifies a color space. Here, a configuration and operation of the display device 100 equipped with a function which automatically specifies a color space from an input image will be described.

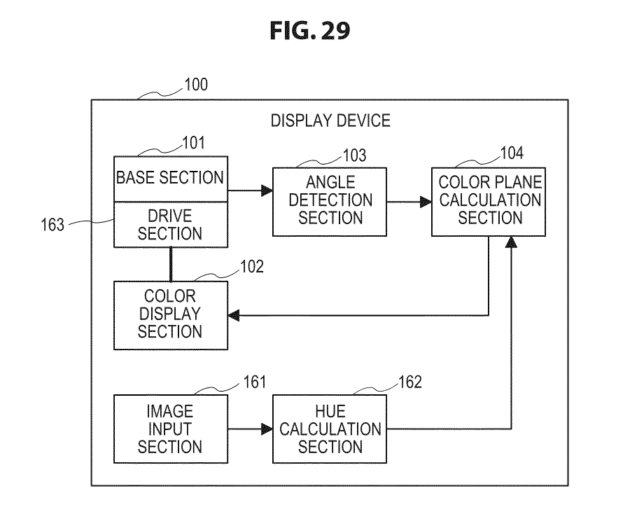

### 1-6-2: Functional Configuration (FIG. 29)

A functional configuration of the display device 100 equipped with an image input function will be described with reference to FIG. 29. As shown in FIG. 29, this display device 100 mainly has a base section 101, a color display section 102, an angle detection section 103, a color plane calculation section 104, an image input section 161, a hue calculation section 162, and a drive section 163. The angle detection section 103 is a means which detects a rotation angle of the color display section 102 with reference to a standard direction S. The rotation angle detected by the angle detection section 103 is input to the color plane calculation section 104. The color plane calculation section 104 selects a hue corresponding to the input rotation angle, and calculates a color plane corresponding to the selected hue. In addition, the color plane calculation section 104 causes the color display section 102 to display the calculated color plane.

However, while the selection of a hue may be performed by a rotation operation of the color display section 102, it is also possible to be performed by image input. For example, when an image is input via the image input section 161, the input image is input to the hue calculation section 162. The hue calculation section 162 maps colors of each of the pixels which constitute the input image to an HSV color space, and detects a hue of each of the pixels. In addition, the hue calculation section 162 calculates a pixel number for each hue, and calculates a histogram related to the hue. Also, the hue calculation section 162 selects a hue with the largest frequency, and inputs information of the selected hue to the color plane calculation section 104. The color plane calculation section 104 calculates a color plane corresponding to the hue shown by the input information, and updates the display content of the color display section 102 with the calculated color plane.

Further, the hue calculation section 162 calculates a rotation angle of the color display section 102 corresponding to the selected hue, and inputs information of the calculated rotation angle to the drive section 163. When information of the rotation angle is input, the drive section 163 automatically moves the color display section 102 to a position of the rotation angle shown by the input information. Note that, while a configuration which calculates a histogram of hues for the entire image input to the image input section 161 has been introduced in the above described description, it may be modified to a configuration which calculates a histogram of hues for a partial region of the image selected by a user.

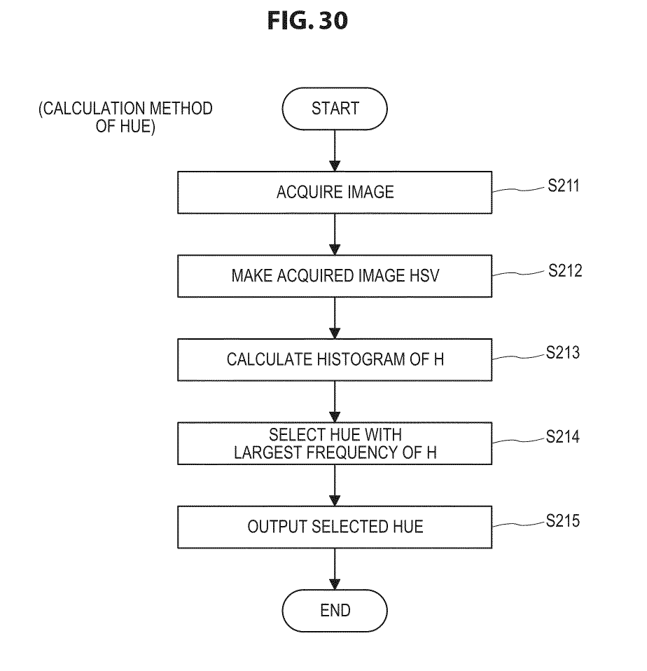

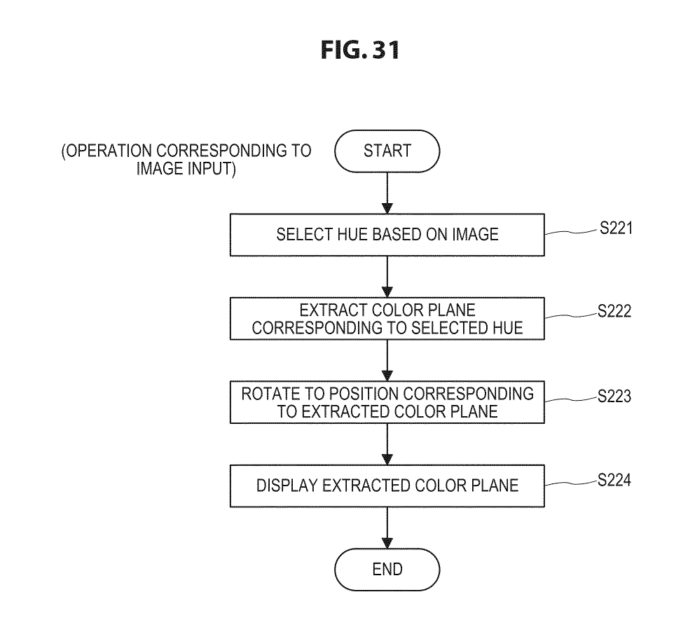

### 1-6-3: Operation (FIG. 30 and FIG. 31)

Next, a calculation method of a hue will be described with reference to FIG. 30. As shown in FIG. 30, first, the display device 100 acquires an image (S211). Next, the display device 100 maps (makes HSV) colors of each of the pixels which constitute the image acquired in step S211 to an HSV color space, by a function of the hue calculation section 162 (S212). Next, the display device 100 calculates a histogram of hues H, by a function of the hue calculation section 162 (S213). Next, the display device 100 selects a hue with the largest frequency of the hues H, based on the histogram calculated in step S213, by a function of the hue calculation section 162 (S214). Next, the display device 100 outputs the hue selected in step S214 (S215), and the series of processes related to the calculation of a hue ends.

Next, an operation corresponding to image input will be described with reference to FIG. 31. As shown in FIG. 31, first, the display device 100 selects a hue based on an input image, by the method shown in FIG. 30 (S221). Next, the display device 100 extracts a color plane corresponding to the hue selected in step S221, by a function of the color plane calculation section 104 (S222). Next, the display device 100 rotatably moves the color display section 102 to a position of the rotation angle corresponding to the hue selected in step S221 (the color plane extracted in step S222), by a function of the drive section 163 (S223). Next, the display device 100 updates the display content of the color display section 102 with the color plane extracted in step S222 (S224), and the series of processes related to an operation corresponding to image input ends.

### 1-6-4: Modified Example

### Application to Character Input

Also, while a calculation method of a hue by image input has been described up until here, it may be constituted so that a hue can be selected based on an input of text information (characters). For example, it may be constituted so that code information of colors, general names or the like can be input with characters. Further, it may be constituted so that language analysis is performed in accordance with the input of natural sentences, and a hue thought to be close to the intention of a user is selected from information related to the color included in the input natural sentences. For example, it can be considered to be constituted so that expressions related to colors are converted into plausible hues, and a hue with the highest appearance frequency is selected.

Heretofore, a configuration and operation of the display device 100 equipped with an image input function has been described.

As described above, the display device 100 according to the present embodiment is capable of achieving a high resolution color space, from within a limited set space, and can additionally achieve high operability and visibility. Further, it is also possible to function as an input device for specifying a desired color from the color space by including an input function. Note that, while various types of functions have been introduced in the above described description, it is possible to arbitrarily combine these functions. It is needless to say that such combinations also belong to the technical scope of the present embodiment.

### 2: The Second Embodiment

In the Case where there are a Plurality of Color Planes

Next, a second embodiment of the present disclosure will be described. The present embodiment is related to a configuration of a display device 200 in which a plurality of display devices (color display sections 202) which display color planes are included.

### 2-1: Basic Configuration of the Display Device 200

A basic configuration of the display device 200 according to the present embodiment will be described.

### 2-1-1: External Appearance and Display Operation (FIG. 32)

As shown in FIG. 32, the display device 200 according to the present embodiment has a base section 201, and a plurality of color display sections 202 (color display sections 202A, 202B and 202C) connected to the base section 201 in a rotatable state with reference to a rotation axis P. In the example of FIG. 32, a configuration of the display device 200 having the three color display sections 202A, 202B and 202C is shown. Note that, the number of the color display sections 202 is not limited to 3, and may be 2 or 4 or more. Further, the color display sections 202A, 202B and 202C may each be constituted so as to be able to independently rotate, and the rotation operation may be limited so that positions are mutually separated by a prescribed rotation angle or more.

Note that, each of the color display sections 202 are display devices capable of displaying a color plane such as a Munsell color chart, similar to that of the color display section 102 according to the first embodiment. For example, a thin display such as a liquid crystal display or an organic electroluminescent display can be used as each of the color display section 102. Further, for example, a flexible display or the like constituted by an organic thin film transistor is capable of being applied as a form of each of the color display section 202.

The color plane displayed on each of the color display section 202 is constituted so as to change in accordance with a rotation angle of each of the color display section 202. Specifically, some standard direction S is set, and the color plane displayed on each of the color display section 202 changes in accordance with a rotation angle with respect to this standard direction S. For example, certain rotation angles from the standard direction S and color hues are associated with each other, and in accordance with the rotation angles from the standard direction S, a Munsell color chart of the hues corresponding to these rotation angles are shown on each the color display section 202.

As described above, the display device 200 has a function which changes the content of the color plane displayed on each of the color display section 202 by a rotation operation of each of the color display section 202. Note that, it may be constituted so that the color plane continuously changes in accordance with the rotation of each of the color display section 202, or may be constituted so as to change by discretely changing. Further, in the case of being constituted so as to discretely change, this change amount (for example, an association relation between a rotation angle width and a change width of the hue) is capable of being arbitrarily set. That is, the display device 200 according to the present embodiment is capable of achieving a high resolution without sacrificing elements such as operability and visibility. Hereinafter, a functional configuration of the display device 200 having such a basic configuration will be described in more detail.

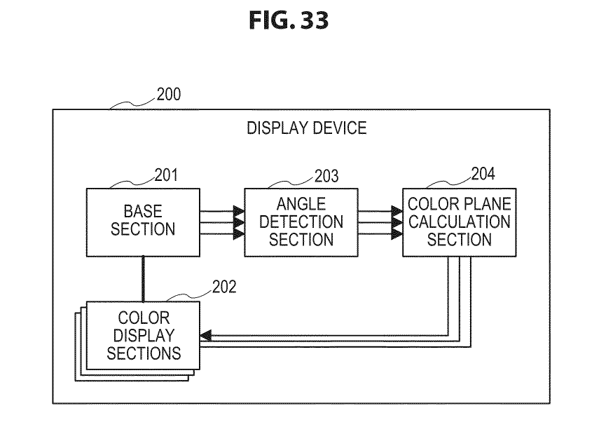

### 2-1-2: Functional Configuration (FIG. 33)

A functional configuration of the display device 200 equipped with a basic configuration will be described with reference to FIG. 33. As shown in FIG. 33, this display device 200 mainly has a base section 201, plurality of color display sections 202, an angle detection section 203, and a color plane calculation section 204. The angle detection section 203 is a means which detects a rotation angle of each of the color display section 202 with reference to a standard direction S. The rotation angle of each of the color display section 202 detected by the angle detection section 203 is input to the color plane calculation section 204. The color plane calculation section 204 selects a hue corresponding to the input rotation angle, and calculates a color plane corresponding to the selected hue. In addition, the color plane calculation section 204 causes corresponding color display section 202 to display the calculated color plane.

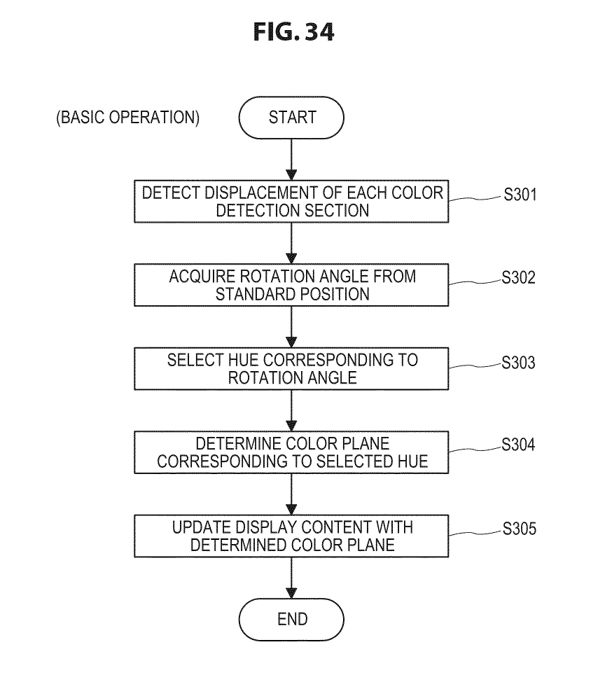

### 2-1-3: Operation (FIG. 34)

Next, an operation of the display device 200 having a basic configuration will be described with reference to FIG. 34. As shown in FIG. 34, first, the display device 200 detects a displacement of each of the color display section 202, by a function of the angle detection section 203 (S301). Next, the display device 200 acquires a rotation angle of each of the color display section 202 from a standard position (standard direction S), by a function of the angle detection section 203 (S302). Next, the display device 200 selects a hue corresponding to the rotation angle acquired in step S302, by a function of the color plane calculation section 204 (S303). Next, the display device 200 determines a color plane corresponding to the selected hue, by a function of the color plane calculation section 204 (S304). Next, the display device 200 updates the display content of the color display section 202 with the color plane determined in step S304, by a function of the color plane calculation section 204 (S305), and the series of operations ends. Note that, the operations of steps S301 to S305 are executed each time a displacement of the color display section 202 is detected.

Heretofore, a configuration and operation of the display device 200 having a basic configuration has been described.

### 2-2: Configuration of the Display Device 200 Equipped with a Mode Switching Function

Next, a configuration of the display device 200 equipped with a mode switching function will be described.

### 2-2-1: The Mode Switching Function

A configuration in which a color plane changes in accordance with a rotation angle of each of the color display sections 202 has been described up until here. However, there will be cases where, in the case where a desired color plane is obtained, the display of this color plane is wanted to be fixed. In particular, there will be cases where a color plane is fixed by one color display section 202, and a comparison of color planes is wanted to be performed while moving the other color display sections 202. In such a case, it is not preferable for the color display section 202, in which the color plane to be fixed is displayed, to rotate for some reason, and for the color plane to be changed. Accordingly, the present inventors have devised a method which controls a change of the color plane, by using a color changing mode capable of changing the color plane in accordance with the rotation of the color display sections 202, and a color fixing mode in which the color plane is fixed regardless of the rotation of the color display sections 202. Hereinafter, a configuration and operation of the display device 100 equipped with this mode switching function will be described.

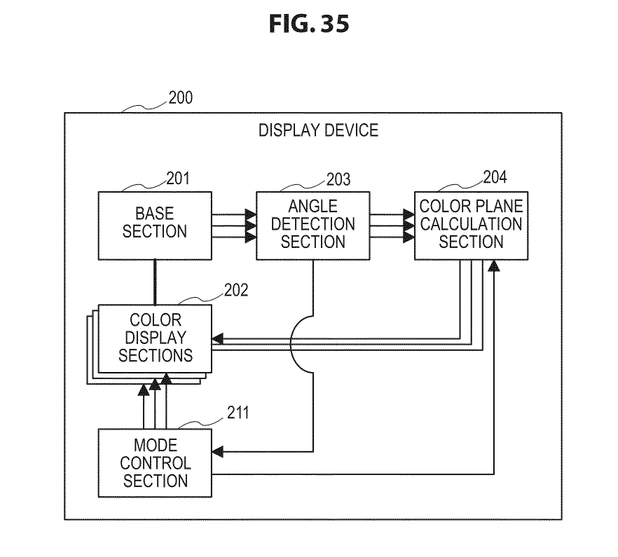

### 2-2-2: Functional Configuration (FIG. 35)

A functional configuration of the display device 200 equipped with a mode switching function will be described with reference to FIG. 35. As shown in FIG. 35, this display device 200 mainly has a base section 201, plurality of color display sections 202, an angle detection section 203, a color plane calculation section 204, and a mode control section 211. The angle detection section 203 is a means which detects a rotation angle of each of the color display section 202 with reference to a standard direction S. The rotation angle of each of the color display section 202 detected by the angle detection section 203 is input to the color plane calculation section 204. The color plane calculation section 204 selects a hue corresponding to the input rotation angle, and calculates a color plane corresponding to the selected hue. In addition, the color plane calculation section 204 causes corresponding color display section 202 to display the calculated color plane.

Further, in the case where the operation mode targeted for a certain color display section 202 is set to the color changing mode, the mode control section 211 sets the operation mode of the other color display sections 202 to the color fixing mode. Also, the mode control section 211 inputs notification signals for notifying the operation mode related to the color display sections 202 set to the color fixing mode to the targeted color display section 202, the angle detection section 203 and the color plane calculation section 204, and performs a control so that the color plane does not change in accordance with the rotation of the targeted color display section 202. On the other hand, the mode control section 211 inputs notification signals for notifying the operation mode related to the color display section 202 set to the color changing mode to the targeted color display section 202, the angle detection section 203 and the color plane calculation section 204, and performs a control so that the color plane of this color display section 202 changes in accordance with the rotation of the targeted color display section 202.

In this way, by being able to control the operation mode, it becomes possible to easily perform a comparison of color planes, while fixing a color plane to be a standard and moving the color display section 202.

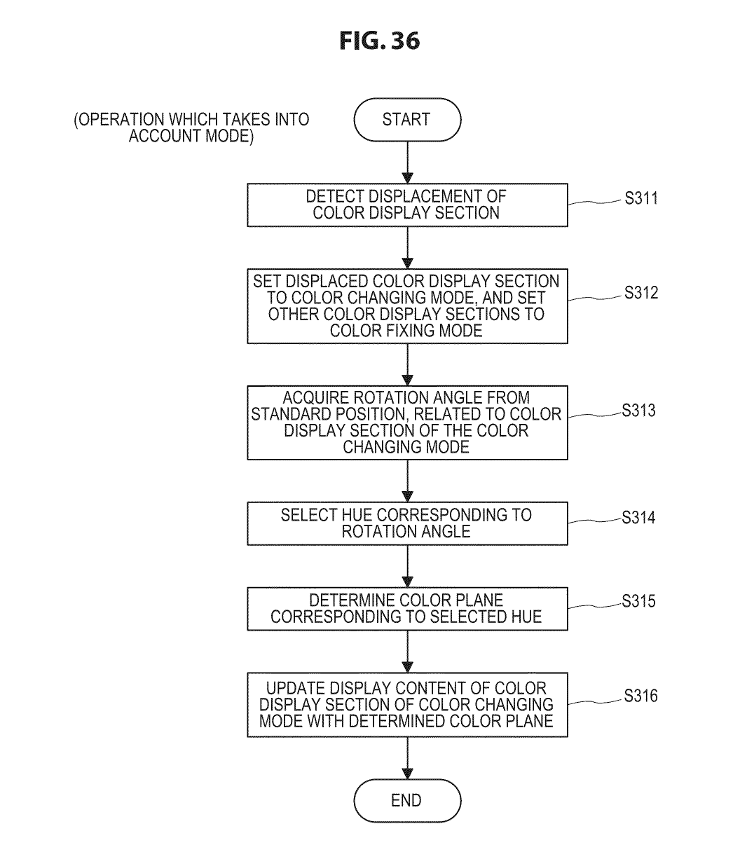

### 2-2-3: Operation (FIG. 36)

Next, an operation of the display device 200 which takes into account the setting of the operation mode will be described with reference to FIG. 36. As shown in FIG. 36, first, the display device 200 detects a displacement of each of the color display sections 202, by a function of the angle detection section 203 (S311). Next, the display device 200 sets a displaced color display section 202 to the color changing mode, and sets the other color display sections 202 to the color fixing mode, by a function of the mode control section 211 (S312). Note that, the setting of the color changing mode and the color fixing mode may be automatically performed such as in step S312, or may be performed manually by a user input. Here, an operation example in the case where the setting of the operation mode is automatically performed will be introduced.

Next, the display device 200 acquires a rotation angle of the color display section 202 set to the color changing mode, by a function of the angle detection section 203 (S313). Next, the display device 200 selects a hue corresponding to the rotation angle acquired in step S313, by a function of the color plane calculation section 204 (S314). Next, the display device 200 determines a color plane corresponding to the hue selected in step S314, by a function of the color plane calculation section 204 (S315). Next, the display device 200 updates the display content of the color display section 202 set to the color changing mode with the color plane determined in step S315 (S316), and the series of processes according to an operation of the display device 200 which take into account the setting of the operation mode ends.

Heretofore, a configuration and operation of the display device 200 equipped with a mode switching function has been described.

### 2-3: Combination of Various Types of Functions

Here, a method which combines the various types of functions described in the above described first embodiment with the display device 200 according to the present embodiment will be described.

### 2-3-1: Combination with the Input Function

First, a combination with the input function will be described. The combination with the input function is capable of being implemented by including an input device such as a touch panel in the display device 200. Further, it is possible to implement the display of color information illustrated in FIG. 11 and FIG. 12, or the display operation at the time of color specification shown in FIG. 13 to FIG. 16, in the display device 200 as they are. In addition, by including functions the same as those of the history management section 122 and the drive section 123 in the display device 200, it is possible to add the history functions shown in FIG. 17 to FIG. 19 to the display device 200. Also, it is possible to add the external output function shown in FIG. 20 by expanding the functions of the color display section 202. Further, it is possible to add a color mixing function, which mixes colors specified in the case where a plurality of colors have been specified, to the display device 200. In this way, it is possible to similarly combine the input function of the display device 100 according to the first embodiment with the display device 200.

### 2-3-2: Combination with the Resolution Switching Function

Next, a combination with the resolution switching function will be described. The combination with the resolution switching function is capable of being implemented by adding a function similar to that of the resolution input section 132 according to the first embodiment to the display device 200. Further, it is also possible to add functions which specify the color display section 202 targeted for switching of the resolution, and switch only the resolution of the specified color display section 202. In addition, it is possible to be constituted so that a plurality of the color display sections 202 are set to the color fixing mode, the plurality of the color display sections 202 are caused to display the same color plane, and display can be performed with mutually different resolutions. Further, a function may be included which similarly arranges the resolutions of the color planes displayed on the plurality of the color display sections 202 with a one-time operation. In this way, it is possible to similarly combine the resolution switching function of the display device 100 according to the first embodiment with the display device 200.

### 2-3-3: Combination with the Color Space Conversion Function

Next, a combination with the color space conversion function will be described. The combination with the color space conversion function is capable of being implemented by adding functions similar to those of the conversion information holding section 151 and the color space conversion section 152 according to the first embodiment to the display device 200. Further, it is possible to add functions which specify the color display section 202 corresponding to the color space conversion function, and convert only the color plane of the specified color display section 202. In addition, it is possible to be constituted so that a plurality of the color display sections 202 are set to the color fixing mode, the plurality of the color display sections 202 are caused to display the same color plane, and the converted color planes can be displayed with mutually different conversion information. Further, a function may be included which arranges the color planes displayed on the plurality of color display sections 202 with the color planes converted by the same conversion information with a one-time operation. In this way, it is possible to similarly combine the color space conversion function of the display device 100 according to the first embodiment with the display device 200.

### 2-3-4: Combination with the Image Input Function

Next, a combination with the image input function will be described. The combination with the image input function is capable of being implemented by adding functions similar to those of the image input section 161 and the hue calculation section 162 according to the first embodiment to the display device 200. However, when an image is input, a mechanism may be necessary which specifies the color display section 202 which applies the selected hue based on the input image. For example, a mechanism can be considered in which some color display section 202 is selected which is at a position closest to a rotation angle corresponding to the selected hue, and the display content of this color display section 202 is updated. Further, it may be a mechanism in which a user sets in advance the color display section 202 in which the display content is to be updated. In addition, it may be constituted so that the display content of a color display section 202 set to the color changing mode is automatically updated. In this way, it is possible to similarly combine the image input function of the display device 100 according to the first embodiment with the display device 200.

Heretofore, a method which combines the various types of functions described in the above described first embodiment with the display device 200 according to the present embodiment has been described.

### 3: Hardware Configuration Example

The control function and calculation function of the above described display devices 100 and 200 are capable of being implemented, for example, by using the hardware configuration shown in FIG. 37. That is, the control function and the calculation function of each of these constituent elements are implemented by controlling the hardware shown in FIG. 3 by using computer programs.

As shown in FIG. 37, this hardware mainly has a CPU 902, a ROM 904, a RAM 906, a host bus 908, and a bridge 910. In addition, this hardware has an external bus 912, an interface 914, an input section 916, an output section 918, a storage section 920, a drive 922, a connection port 924, and a communication section 926. However, the above described CPU is an abbreviation of a Central Processing Unit. Further, the above described ROM is an abbreviation of a Read Only Memory. Also, the above described RAM is an abbreviation of a Random Access Memory.

The CPU 902 functions, for example, as a calculation processing device or a control device, and controls all or part of the operations of each of the constituent elements based on various types of programs recorded in the ROM 904, the RAM 906, the storage section 920 or a removable recording medium 928. The ROM 904 is a means which stores programs to be read in the CPU 902, data used for calculations or the like. For example, programs to be read in the CPU 902, various types of data which arbitrarily change when executing these programs or the like are temporarily or permanently stored in the RAM 906.

These constituent elements are mutually connected, for example, via the host bus 908 which is capable of performing high-speed data transmission. On the other hand, for example, the host bus 908 is connected to the external bus 912 with a comparatively lower data transmission speed via the bridge 910. Further, for example, a mouse, keyboard, touch panel, buttons, switches, levers or the like can be used as the input section 916. In addition, a remote controller capable of transmitting control signals by using infrared rays or electromagnetic waves other than these can also be used as the input section 916.

For example, there are devices capable of visually or aurally notifying acquired information to a user, such as a display device such as a CRT, LCD, PDP or ELD, an audio output device such as a speaker or headphones, a printer, a mobile phone or a facsimile, as the output section 918. However, the above described CRT is an abbreviation of a Cathode Ray Tube. Further, the above described LCD is an abbreviation of a Liquid Crystal Display. Also, the above described PDP is an abbreviation of a Plasma Display Panel. In addition, the above described ELD is an abbreviation of an Electro-Luminescence Display.

The storage section 920 is a device for storing various types of data. For example, a magnetic storage device such as a hard disk drive (HDD), a semiconductor storage device, an optical storage device, a magneto-optical storage device or the like can be used as the storage section 920. However, the above described HDD is an abbreviation of a Hard Disk Drive.

The drive 922 is, for example, a device which reads information recorded on the removable recording medium 928 such as a magnetic disk, an optical disk, a magneto-optical disk or a semiconductor memory, or writes information to the removable recording medium 928. For example, the removable recording medium 928 is a DVD media, a Blu-ray (registered trademark) media, an HD DVD media, various types of semiconductor storage media or the like. It is needless to say that the removable recording medium 928 may be, for example, an IC card equipped with a contactless IC chip, an electronic device or the like. However, the above described IC is an abbreviation of an Integrated Circuit.

The connection port 924 is, for example, a port for connecting an external connection device 930 such as a USB port, an IEEE1394 port, an SCSI, an RS-232C port or an optical audio terminal. For example, the external connection device 930 is a printer, a portable music player, a digital camera, a digital video camera, an IC recorder or the like. However, the above described USB is an abbreviation of a Universal Serial Bus. Further, the above described SCSI is an abbreviation of a Small Computer System Interface.

The communication section 926 is a communication device for connecting to a network 932, and is, for example, a wired or wireless LAN, Bluetooth (registered trademark), a communication card for WUSB, a router for optical communication, a router for ADSL, a modem for various types of communication or the like. Further, the network 932 connected to the communication section 926 is constituted by a network connected by wires or wirelessly, and for example, is the internet, a home LAN, infrared communication, visible light communication, a broadcast, satellite communication or the like. However, the above described LAN is an abbreviation of a Local Area Network. Further, the above described WUSB is an abbreviation of a Wireless USB. Also, the above described ADSL is an abbreviation of an Asymmetric Digital Subscriber Line.

### 4: Conclusion

Finally, the technical idea of the present embodiment will be simply concluded. The technical idea which is described hereinafter can be used, for example, by combining with various types of information processing apparatuses, such as PC, a mobile phone, a game machine, an information terminal, a home information appliance or a car navigation system.

Additionally, the present technology may also be configured as below.

(1)

A display device, including:
a color display section which displays a color plane expressed by first and second attribute values from among three attribute values constituting a color system;
a base section to which the color display section is connected in a rotatable state; and
a display control section which changes the color plane in accordance with a rotation angle of the color display section.

When applying the above described configuration (1), it becomes possible to continuously change the color plane in accordance with the rotation of the color display section. Further, even in the case where the color plane is discretely changed in accordance with the rotation of the color display section, it becomes possible to arbitrarily adjust the resolution by adjusting the fineness of these discrete values. It is needless to say that, in the case where the above described configuration is applied, the size of the display device will not change, even if the resolution is raised. Accordingly, it becomes possible to express a color space of a high resolution with space savings. Further, since the color plane can be changed by an intuitive operation such as the rotation of the color display section, a high operability will be achieved. In addition, since a three-dimensional color space becomes easy to image due to the rotation of the color display section, the retrievability when retrieving a desired color will increase.

(2)

The display device according to (1),
wherein the rotation angle of the color display section is associated with the third attribute value different to the first and the second attribute values, and
wherein the display control section detects the third attribute value corresponding to the rotation angle of the color display section, and causes the color display section to display a color space corresponding to the detected third attribute value.
   (3)

The display device according to (1) or (2), further including:
an input section capable of specifying a color corresponding to a region within the color plane by contacting a region within the color plane displayed on the color display section.
   (4)

The display device according to (3),
wherein, in a case where a color is specified via the input section, the display control section causes the color display section to display information related to the specified color.
   (5)

The display device according to any one of (1) to (4),
wherein, in a case where a resolution is specified by a user, the display control section changes a resolution of the color plane to the specified resolution.
   (6)

The display device according to any one of (1) to (5),
wherein the color display section has a color changing mode and a color fixing mode as operation modes, and
wherein, in a case where the color display section is a color fixing mode, the display control section does not change the color plane even if the rotation angle of the color display section changes.
   (7)

The display device according to (1), further including:
a plurality of color display sections capable of mutually and independently rotating,
wherein the display control section changes a color plane displayed on each of the color display sections in accordance with a rotation angle of each of the color display sections.
   (8)

The display device according to (7),
wherein each of the color display sections has a color changing mode and a color fixing mode as operation modes, and
wherein, in a case where one of the color display sections is a color changing mode, the other color display sections are set to a color fixing mode, and the display control section does not change the color planes displayed on the other color display sections even if rotation angles of the other color display sections set to the color fixing mode change.
   (9)

The display device according to any one of (1) to (8), further including:
a conversion information holding section which holds one or a plurality of pieces of conversion information for converting one color plane into another color plane with a different appearance,
wherein, in a case where the conversion information is selected, the display control section causes the color display section to display a color plane converted by using the selected conversion information.
   (10)

The display device according to any one of (1) to (8), further including:
a conversion information holding section which holds one or a plurality of pieces of conversion information for converting one color plane into another color plane with a different appearance,
wherein the display control section causes the color display section to display a color plane converted by using the conversion information while changing the conversion information with a prescribed timing.
   (11)

The display device according to any one of (1) to (10),
wherein the base section has a drive mechanism which rotates the color display section with a fixed speed.
   (12)

The display device according to (3), further including:
a color information provision section configured to provide, in a case where a color is specified via the input section, information related to the specified color to an external device.
   (13)

The display device according to any one of (1) to (12),
wherein, in a case where an alpha value representing transparency is prepared, the display control section causes the color display section to display a color plane which takes into account the alpha value.
   (14)

The display device according to (3),
wherein, in a case where a color is specified via the input section, the display control section controls the color display section so as to set colors other than the specified color to not be displayed, or to change a display position of the specified color.
   (15)

The display device according to (3), further including:
a history holding section which holds a history of colors specified via the input section,
wherein the base section has a drive mechanism which, in a case where a color is selected from the history of colors, moves the color display section to a position of a rotation angle corresponding to a color plane including the selected color, and
wherein the display control section causes the color display section to display the color plane including the selected color.
   (16)

The display device according to (1), further including:
an image input section configured to input an image;
an image analysis section which extracts a hue with a highest appearance frequency from within an input image; and
a color plane selection section which selects a color plane corresponding to the hue with the highest appearance frequency,
wherein the display control section causes the color display section to display the color plane selected by the color plane selection section.
   (17)

A display method, including:
changing, by a display device having a color display section which displays a color plane expressed by first and second attribute values from among three attribute values constituting a color system, and a base section to which the color display section is connected in a rotatable state, the color plane in accordance with a rotation angle of the color display section.

### (Remarks)

The above described angle detection sections 103, 203, color plane calculation sections 104, 204, color display sections 102, 202, 202A, 202B, 202C, history management section 122, mode switching section 141, color space conversion section 152 and mode control section 211 are examples of a display control section. The above described touch panels 121, 131 are examples of an input section. The above described color display sections 102, 202, 202A, 202B, 202C are examples of a color information provision section. The above-described drive sections 111, 123, 163 are examples of a drive mechanism. The above-described hue calculation section 162 is an example of an image analysis section. The above described color plane calculation sections 104, 204 are examples of a color plane selection section.

The preferred embodiments of the present invention have been described above with reference to the accompanying drawings, whilst the present invention is not limited to the above examples, of course. A person skilled in the art may find various alterations and modifications within the scope of the appended claims, and it should be understood that they will naturally come under the technical scope of the present invention.

For example, while a touch panel is introduced in the above description as an example of the input device, various types of operation devices, such as a keyboard, a mouse, a touch pad or a remote controller, can be used as the input device. Further, while a Munsell color system is shown as an example of a color space capable of being applied, it is also possible to be similarly applied to a color system other than this. Further, while a configuration which associates a rotation angle and a hue, and displays a color plane formed by saturation and brightness, has been illustrated, it may be modified to a different configuration which associates one arbitrary attribute value constituting a color system with a rotation angle, and displays a color plane formed by two other attribute values.

Further, for example, the specification method of the resolution may be a mechanism which specifies “displaying the saturation for each n units”, “displaying the brightness with m divisions” or the like. Further, while the color display sections 102 and 202 are capable of being constituted by an arbitrary display device, it is preferable to be constituted by a light-weight display device. Further, the case where a pressing force to the touch panels 121 and 131 exceeds a threshold can be illustrated as a trigger which displays color information. In this case, a touch panel capable of detecting a pressing force is used as the touch panels 121 and 131. Further, in the case where a transparent display is used as the color display sections 102 and 202, it is possible to be implemented by taking into account an alpha value representing transparency.

Further, a function which displays the color plane at random, an operation which rotates the color display sections 102 and 202 at random or the like may be programmed as an operation of the display devices 100 and 200. Further, a function which expresses a three-dimensional color space using an after image, by rotating the color display sections 102 and 202 at high speed while displaying a color plane corresponding to a rotation angle, may be built into the display devices 100 and 200. Further, a drive control function which automatically arranges a plurality of the color display sections 202 with equal angle intervals, or which automatically arranges at prescribed setting angles, may be built into the display device 200. Such a combination of functions also belongs to the technical scope according to the embodiments of the present disclosure.

### REFERENCE SIGNS LIST

100, 200 display device
101, 201 base section
102, 202, 202A, 202B, 202C color display section
103, 203 angle detection section
104, 204 color plane calculation section
111, 123, 163 drive section
121, 131 touch panel
122 history management section
132 resolution input section
141 mode switching section
151 conversion information holding section
152 color space conversion section
161 image input section
162 hue calculation section
211 mode control section

1. A display device, comprising:
a color display section which displays a color plane expressed by first and second attribute values from among three attribute values constituting a color system;
a base section to which the color display section is connected in a rotatable state; and
a display control section which changes the color plane in accordance with a rotation angle of the color display section.

2. The display device according to claim 1,
wherein the rotation angle of the color display section is associated with the third attribute value different to the first and the second attribute values, and
wherein the display control section detects the third attribute value corresponding to the rotation angle of the color display section, and causes the color display section to display a color space corresponding to the detected third attribute value.

3. The display device according to claim 1, further comprising:
an input section capable of specifying a color corresponding to a region within the color plane by contacting a region within the color plane displayed on the color display section.

4. The display device according to claim 3,
wherein, in a case where a color is specified via the input section, the display control section causes the color display section to display information related to the specified color.

5. The display device according to claim 1,
wherein, in a case where a resolution is specified by a user, the display control section changes a resolution of the color plane to the specified resolution.

6. The display device according to claim 1,
wherein the color display section has a color changing mode and a color fixing mode as operation modes, and
wherein, in a case where the color display section is a color fixing mode, the display control section does not change the color plane even if the rotation angle of the color display section changes.

7. The display device according to claim 1, further comprising:
a plurality of color display sections capable of mutually and independently rotating,
wherein the display control section changes a color plane displayed on each of the color display sections in accordance with a rotation angle of each of the color display sections.

8. The display device according to claim 7,
wherein each of the color display sections has a color changing mode and a color fixing mode as operation modes, and
wherein, in a case where one of the color display sections is a color changing mode, the other color display sections are set to a color fixing mode, and the display control section does not change the color planes displayed on the other color display sections even if rotation angles of the other color display sections set to the color fixing mode change.

9. The display device according to claim 1, further comprising:
a conversion information holding section which holds one or a plurality of pieces of conversion information for converting one color plane into another color plane with a different appearance,
wherein, in a case where the conversion information is selected, the display control section causes the color display section to display a color plane converted by using the selected conversion information.

10. The display device according to claim 1, further comprising:
a conversion information holding section which holds one or a plurality of pieces of conversion information for converting one color plane into another color plane with a different appearance,
wherein the display control section causes the color display section to display a color plane converted by using the conversion information while changing the conversion information with a prescribed timing.

11. The display device according to claim 1,
wherein the base section has a drive mechanism which rotates the color display section with a fixed speed.

12. The display device according to claim 3, further comprising:
a color information provision section configured to provide, in a case where a color is specified via the input section, information related to the specified color to an external device.

13. The display device according to claim 1,
wherein, in a case where an alpha value representing transparency is prepared, the display control section causes the color display section to display a color plane which takes into account the alpha value.

14. The display device according to claim 3,
wherein, in a case where a color is specified via the input section, the display control section controls the color display section so as to set colors other than the specified color to not be displayed, or to change a display position of the specified color.

15. The display device according to claim 3, further comprising:
a history holding section which holds a history of colors specified via the input section,
wherein the base section has a drive mechanism which, in a case where a color is selected from the history of colors, moves the color display section to a position of a rotation angle corresponding to a color plane including the selected color, and
wherein the display control section causes the color display section to display the color plane including the selected color.

16. The display device according to claim 1, further comprising:
an image input section configured to input an image;
an image analysis section which extracts a hue with a highest appearance frequency from within an input image; and
a color plane selection section which selects a color plane corresponding to the hue with the highest appearance frequency,
wherein the display control section causes the color display section to display the color plane selected by the color plane selection section.

17. A display method, comprising:
changing, by a display device having a color display section which displays a color plane expressed by first and second attribute values from among three attribute values constituting a color system, and a base section to which the color display section is connected in a rotatable state, the color plane in accordance with a rotation angle of the color display section.
